(19) United States
(12) Patent Application Publication
(10) Pub. No.: US 2002/0131431 A1
(43) Pub. Date: Sep. 19, 2002

(54) Method and apparatus for a network element to support a communication link in a communication network

(76) Inventors: Richard B. Wank, Dallas, TX (US); Michael T. Raftelis, Frisco, TX (US)

Correspondence Address: Garlick & Harrison, P.O. Box 342019, Austin, TX, 78734, US

(21) Appl. No.: 09/965,363

(22) Filed: Sep. 27, 2001

Related U.S. Application Data
(60) Provisional application No. 60/275,630, filed on Mar. 14, 2001.

(51) Int. Cl. H04L 12/28

(52) U.S. Cl. 370/403; 370/228

(57) ABSTRACT

A SONET network element or network switch includes a control layer implemented over a physical layer to automate the establishment, modification, and/or deletion of communication links within the communication network. In general, the network element may include firmware to support processing that begins by receiving a link command and determining the type of link command. When the type of link command is to establish a connection, the processing continues by determining whether the network element is a termination node of the communication link. When the network element is not a termination node of the communication link, the processing continues by determining an optimal path for the communication link via a plurality of network elements of the communication network. The processing continues by determining the type of path to the adjacent network element of the plurality of network elements. The processing continues by processing the link command based on the type of path to the adjacent network element to establish the communication link.

### TECHNICAL FIELD OF THE INVENTION

This invention relates generally to telecommunication systems and more particularly to network switches and/or transport network elements within SONET and/or SDH networks.

### BACKGROUND OF THE INVENTION

Bandwidth is one of the hottest buzzwords in the telecommunication industry today and will be for quite some time to come. Bandwidth is the key to the number of users a communication system can support at any given time, the amount of data that can be transported via the communication system at any given time, and the speed at which the data can be transported. It is no wonder why scores of companies spend billions of dollars annually to develop equipment to increase the bandwidth of communication systems, such as the public switch telephone network (PSTN), wireless communication systems, wire line communication systems, and/or the Internet.

To ensure that the various companies' equipment is interoperable within a communication system and between communication systems, standards have been developed. One key telecommunication standard is the Open Systems Interconnection (OSI), which is currently the only internationally accepted framework of standards for communication between different systems made by different vendors. In general, OSI provides for an open system networking environment for any vendor's computer system, connected to any network, to freely share data with any computer system on the network. To achieve the open system networking environment, OSI organizes the communication process into seven different layered sequences based on their relationship to the user. Of the seven layers, layers 1 through 3 deal with network access, while layers 4 through 7 deal with end-to-end communications between the message source and the message destination. The seven layers are:

Physical layer (Layer 1) provides for the electrical, mechanical and functional controls of data circuits for transceiving data over transmission lines.

Data link layer (Layer 2) provides for the procedures and protocols for operating the transmission lines. Such procedures and protocols include error detection and correction means.

Network layer (Layer 3) provides for the transfer of data between computers and address routing within and between the individual networks.

Transport layer (Layer 4) provides for the rules for information exchange and manages end-to-end delivery of information within and between networks, including error recovery and flow control.

Session layer (Layer 5) provides for the control of the basics communication facility provided by the transport layer (Layer 4).

Presentational layer (Layer 6) provides transparent communication services by masking the differences of varying data formats between dissimilar layers.

Applications layer (Layer 7) contains functions for particular application services, such as file transfers, remote file access and virtual terminals.

Another key standard, which is based on OSI, which provides for high bandwidth communication systems, is SONET (Synchronous Optical NETwork). SONET was created in 1985 to provide a cost effective platform for multi-vendor internetworking and offers the advantages of back-to-back multiplexing, compatibility with other standards, and ultra high performance. In particular, SONET is a transmission technology, which resides in the physical layer (Layer 1), and can be used to carry a wide variety of types of traffic, including ATM (Asynchronous Transfer Mode) cells. In addition, the SONET physical layer may be used in a wide variety of applications, including LAN-to-LAN interconnections, host-to-host interconnections, video conferencing, team engineering, distributed processing, and advanced scientific research.

The basic building blocks of a SONET system are 125 micro second frames that come in various sizes of synchronous transport signal (STS) frames, such as STS-1, STS-3, STS-12, STS-48, STS-n. An STS-1 frame provides a bit rate of 51.84 megabits per second (Mbps), an STS-3 frame provides a bit rate of 155.52 Mbps, an STS-12 frame provides a bit rate of 622.08 Mbps, and an STS-48 frame provides a bit rate of 2.48832 Giga bits per second (Gbps). Once an STS frame is converted from an electrical format into an optical format for transmission, the frame is then referred to as an optical carrier (OC), but still has the same bit rate as the STS frame.

As mentioned, SONET is a transmission technology, which differs from switching technology. Switching technology is concerned with how data is routed across the network, while transmission technology is concerned with how data is encoded and transported across the network. SONET, therefore, separates the overhead of switching technology, such as ATM, from the payload fields (i.e. the data). As such, SONET is not applied directly to the switching devices of a network, but is used to specify the interface between the switches that are linked by optical fibers. Thus, standard ATM or LAN switches are equipped with a SONET interface insure the transport of the data.

Because SONET resides in the physical layer, setting up, modifying, and/or deleting communication links within the communication system requires a substantial amount of human interaction. For example, if a communication link spans multiple network switches, or network elements, a network administrator, via a network management system, must access each network switch to allocate resources (e.g., particular lines into/out of the switch, a time slot position, et cetera) for the communication link. This manual process is further complicated when the switches are manufactured by different vendors, which each have their own network management system. When this is the case, the network administrator must access multiple network management systems to establish the communication link. The same is true for modifying a communication link or the deleting a communication link.

Therefore, a need exists for a method and apparatus that substantially automates the establishing, modifying, and/or deleting of communication links in a communication system, or communication network.

### SUMMARY OF THE INVENTION

These needs and others are substantially met by the present invention, which provides a control layer implemented over a physical layer within a network element or a network switch in a communication network. The network element includes firmware to support particular processing to automate the establishment, modification, and/or deletion of communication links within the communication network. In one embodiment, the network element includes processing that begins by receiving a link command. Upon determining the type of link command (e.g., establish a link, delete a link, modify a link), the processing continues based on the type of link. When the type of link command is to establish a connection, i.e. establish a communication link between two ports within the communication network, the network elements determines whether the network element is a termination node of the communication link. When the network element is not a termination node of the communication link, the network element determines an optimal path for the communication link via a plurality of network elements of the communication network. The optimal path may be determined using a known technique such as the Dykstra algorithm, or an equivalent routine.

The network element processing continues by determining the type of path to the adjacent network element of the plurality of network elements. For example, the type of path may be an unprotected linear path, a SONET UPSR, a SONET BLSR, or a one-plus-one protected linear path. The network element processing continues by processing the link command based on the type of path to the adjacent network element to establish the communication link. By providing a control layer within network elements of a communication network, the establishing, modifying, and/or deleting of communication links in a communication system is substantially automated.

In another embodiment, the network element includes firmware that functions to support a communication link in a communication network. The processing performed by the network element begins by receiving a link command and determining whether the link command is a network manager link command or a network element link command. Such a link command identifies the first port and/or second port of the communication link, where a port is a connection point into and/or out of the communication network. When the link command is a network manager link command, the network element continues the processing by determining type of the link command (e.g., establish a link, delete a link, and/or modify a link). When the link command indicates that a link is to be established, the network element determines an optimal path for the communication link to include a plurality of network elements of the communication network.

The network element then determines the type of path to an adjacent network elements based on a link coupling protocol of coupling to the adjacent network element. The link coupling protocol includes, but is not limited to, linear coupling, UPSR SONET ring coupling, and BLSR SONET ring coupling. Having made this determination, the network element processes the link command based on the type of path to the adjacent one of the plurality of network elements. The processing of the link command includes establishing the link, deleting the link, and/or modifying the link.

### BRIEF DESCRIPTION OF THE DRAWINGS

FIG. 1 illustrates a communications system that includes a communication network in accordance with the present invention;

FIG. 2 illustrates a schematic block diagram of a communication network in accordance with the present invention;

FIG. 3 illustrates a schematic block diagram of a network element and network manager in accordance with the present invention;

FIG. 4 illustrates a schematic block diagram of a communication link between various ports of a communication network in accordance with the present invention;

FIGS. 5 and 6 illustrate a logic diagram of a method for processing a network manager command in accordance with the present invention;

FIG. 7 illustrates a schematic block diagram of establishing an unprotected link between two ports of the communication network in accordance with the present invention;

FIG. 8 illustrates a logic diagram of an alternate method for processing a network manager command in accordance with the present invention;

FIG. 9 illustrates a logic diagram of yet another method for processing a network manager command in accordance with the present invention;

FIG. 10 illustrates a schematic block diagram of processing a network command to establish a link between two ports of a communication network in accordance with the present invention;

FIG. 11 illustrates a logic diagram of a method for a network element to support a communication link in accordance with the present invention;

FIG. 12 illustrates a graphical representation of a unidirectional path switched ring (UPSR) in accordance with the present invention;

FIG. 13 illustrates a graphical representation of a bidirectional line switched ring (BLSR) in accordance with the present invention;

FIG. 14 illustrates a logic diagram of a method for processing a command for UPSR coupling in accordance with the present invention;

FIG. 15 illustrates a schematic block diagram of establishing an unprotected link between two ports in a communication network via a UPSR SONET ring in accordance with the present invention;

FIG. 16 illustrates a logic diagram of a method for processing a command for BLSR coupling in accordance with the present invention;

FIG. 17 illustrates a schematic block diagram of establishing an unprotected link between two ports in the communication network via a BLSR SONET ring in accordance with the present invention;

FIG. 18 illustrates a logic diagram of a method for processing a network element command or a network manager command in accordance with the present invention;

FIG. 19 illustrates a logic diagram of a method for processing a delete link command in accordance with the present invention;

FIG. 20 illustrates a logic diagram of a method for processing a delete link command for UPSR coupling in accordance with the present invention;

FIG. 21 illustrates a logic diagram of a method for processing a delete link command for BLSR coupling in accordance with the present invention;

FIG. 22 illustrates a logic diagram for processing a modify link command in accordance with the present invention;

FIG. 23 illustrates a logic diagram of a method for processing a link command that includes protection criteria in accordance with the present invention;

FIGS. 24 and 25 illustrate a logic diagram of a method for processing a link command that includes protection criteria when the link coupling protocol is UPSR in accordance with the present invention;

FIGS. 26 and 27 illustrate a logic diagram of a method for processing a command that includes protection criteria when the link coupling protocol is BLSR in accordance with the present invention;

FIG. 28 illustrates a logic diagram of a method for processing a command that includes link protection criteria when the link coupling protocol is linear in accordance with the present invention;

FIG. 29 illustrates a logic diagram for an alternate method of processing a link command that includes protection criteria in accordance with the present invention;

FIG. 30 illustrates a schematic block diagram of a communication network that includes a plurality of groupings of network elements in accordance with the present invention;

FIG. 31 illustrates a schematic block diagram of groupings of network elements that form a communication link between two ports in accordance with the present invention;

FIG. 32 illustrates a graphical representation of tabular information maintained by a network manager and/or a network element regarding a communication link in accordance with the present invention;

FIG. 33 illustrates a logic diagram of a method for establishing a path identifier in a communication network in accordance with the present invention;

FIG. 34 illustrates a logic diagram of a method for establishing the communication link of the method illustrated in FIG. 33;

FIG. 35 illustrates a logic diagram of an alternate method for establishing a path identifier in a communication network in accordance with the present invention; and

FIG. 36 illustrates a logic diagram of yet another alternate method for establishing a path identifier in a communication network in accordance with the present invention.

### DETAILED DESCRIPTION OF A PREFERRED EMBODIMENT

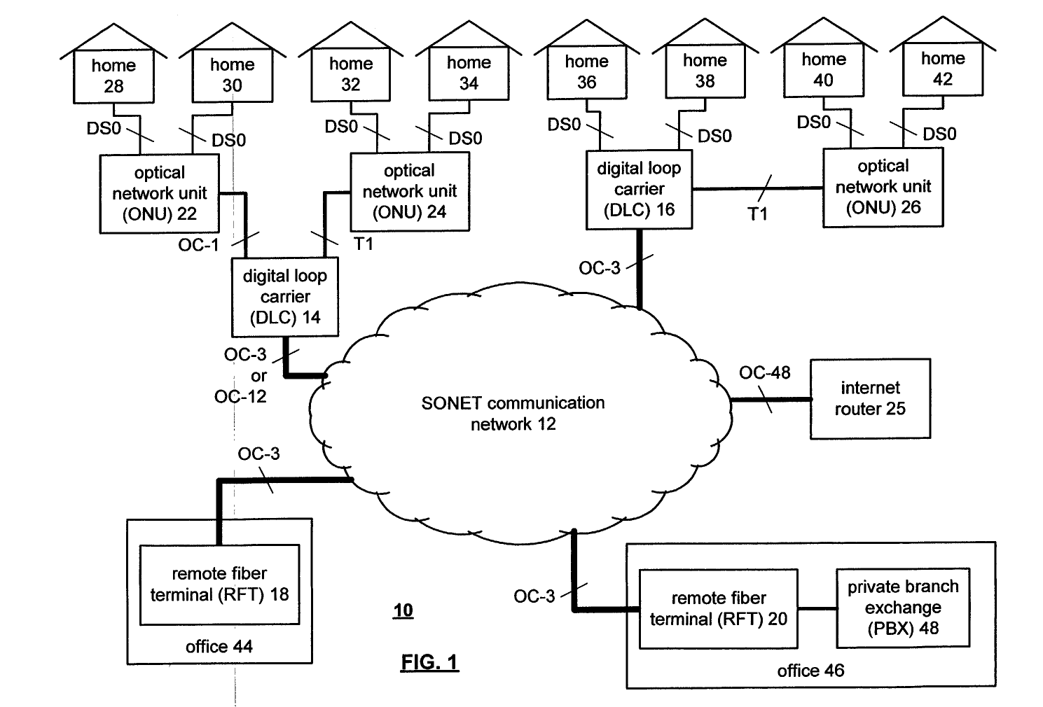

FIG. 1 illustrates a schematic block diagram of a communication system 10 that includes a SONET communication network 12, an SDH (Synchronous Digital Hierarchy) communication network, and/or other physical layer communication network. The communication system 10 further includes a plurality of digital loop carriers (DLC) 14 and 16, a plurality of remote fiber terminals (RFT) 18 and 20, a plurality of optical network units (ONU) 22, 24 and 26, a plurality of homes 28-42, an internet router 25, and a private branch exchange device (PBX) 48. As with any communication system 10, its primary function is to convey data, which may be voice, video, text, multimedia, and/or any combination thereof between users. The users may reside in homes 28-42 and/or in offices 44 and 46.

For home users to transceive data throughout the communication system 10, the home is coupled by one or more DS0 (Digital Signal—0) links to an optical network unit 22, 24 or 26 or directly to a digital loop carrier 16. For example, homes 28 and 30, which represent a multitude of homes in a particular geographic area, are each coupled via a DS0 link to the optical network unit 22. As is known, a DS0 link provides 64 kilobits per second of bandwidth between the receiving party (e.g., the home) and the sending party (e.g., the optical network unit). As one of average skill in the art will readily appreciate, each home may include multi DS0's to increase the bandwidth for the particular home, or be coupled to the communication network via a cable modem, DSL modem, T1 direct link, etc.

The optical network unit 22 interfaces with a plurality of homes 28 and 30 and multiplexes the data of each DS0 line into an OC-1 line or STS-1 line. The OC-1 line or the STS-1 line is operably coupled to the digital loop carrier 14. Similarly, optical network unit 24 interfaces with a plurality of homes 32 and 34 and multiplexes the data from each DS0 link into a T1 link. The T1 link couples optical network unit 24 to the digital loop carrier 14.

The digital loop carrier 14 is operably coupled to a plurality of optical network units 22 and 24, which are representative of a multitude of optical network units. The digital loop carrier 14 multiplexes data of the various types of lines coupling the digital loop carrier 14 to the corresponding optical network units into an OC-3 link or an OC-12 link. As such, the digital loop carrier 14 multiplexes digital trunked signals (e.g., from the T1 link), digital synchronous transport signal (e.g., from the STS-1 link), and optical signals (e.g., from the OC-1 link) into optical signals. The multiplexed signals on the OC-3 link or OC-12 link may be formatted in accordance with SONET, SDH, or any other standardized optical physical layer. The digital loop carrier 14 is operably coupled to the communication network 12 via the OC-3 link or the OC-12 link.

Optical network unit 26 is operably coupled to homes 40 and 42 via DS0 links. The optical network unit 26 multiplexes the DS0 links from homes 40 through 42 on to a T1 link, which is coupled to digital loop carrier 16. Digital loop carrier 16 is also coupled directly to homes 36 and 38, which may be via a DS0 link, an optical carrier link, or a synchronous transport signal link. If the direct connect coupling to the home is via an optical carrier, such direct connect is referred to as fiber-to-the-house (FTTH) or fiber-to-the-curb (FTTC). The digital loop carrier 16 multiplexes the data on the incoming lines from homes 36, 38 and the data on the T1 link from the optical network unit 26 on to an OC-3 link or OC-12 link. The digital loop carrier 16 is operably coupled to the SONET communication network 12 via the OC-3 link or the OC-12 link.

Remote fiber terminals 18 and 20 are implemented in offices 44 and 46, respectively. In operation, the remote fiber terminals function similarly to the digital loop carriers 14 and 16 in that they multiplex data from various lower rate links (OC-1, T1, and/or STS-1) into a higher rate optical carrier link (e.g., OC-3 or OC-12). The remote fiber terminals 18 and 20, however, do not generally interface with an optical network unit because all of the data being multiplexed by the remote fiber terminal is from a single office, which may include a private branch exchange 48.

Regardless of the type of link between the end users and the digital loop carriers 14 and 16 or the remote fiber terminals 18 and 20, the higher bandwidth, multiplexed link from the DLC 14 and 16 or the RFT 18 and 20 are optical carriers and may be formatted in accordance with the SONET standard protocols. In addition, these optical carriers provide the interface between the digital loop carriers 14 and 16 and the network 12 and the interface between the remote fiber terminals 18 and 20 and the network 12.

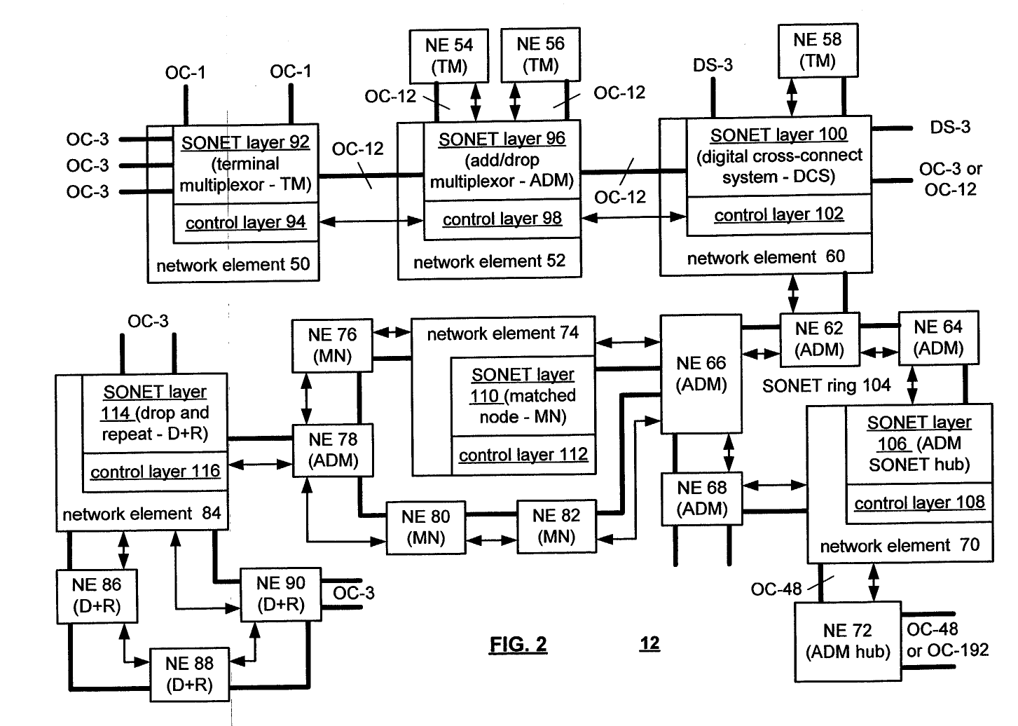

FIG. 2 illustrates a schematic block diagram of the SONET communication network 12 including a plurality of network elements 50, 52, 54, 56, 58, 60, 62, 64, 66, 68, 70, 72, 74, 76, 78, 80, 82, 84, 86, 88, and 90. Each of the network elements may be a network switch supporting a SONET physical layer and a frame relay, an ATM, Internet protocol (IP), and/or digital subscriber loop (DSL) data link layer and/or network layer. In addition to the SONET physical layer, each network element 50-90 includes a control layer. The SONET layer provides the SONET multiplexing/de-multiplexing and data transmission in accordance with the SONET standards. The control layer provides each network element a networking/routing intelligence to automatically manipulate the physical layer connections of the SONET communication network 12.

The SONET layers 92, 96, 100, 106, 110, and 114 may include the SONET physical layer functionality for one or more of terminal multiplexor (TM), add/drop multiplexor (ADM), digital cross-connect system (DCS), ADM SONET hub, matched node (MN), and drop and repeat (D+R). In general, a terminal multiplexor is an endpoint device on the SONET network 12 that gathers bytes to be sent on to the network and delivers bytes from the network. The terminal multiplexor is intended to be the most common type of SONET CPE (customer placed equipment), but is most often used in the serving office as opposed to being located at the customer site.

The add/drop multiplexor is in essence a full-featured terminal multiplexor, which is usually connected to several terminal multiplexors and aggregates or splits (i.e. grooms) SONET traffic at various speeds. The digital cross-connect device can add or drop individual SONET channels (or their components in a VT-virtual tributary-environment) at a given location. The digital cross-connect device is an even more sophisticated version of a SONET ADM. The matched node device interconnects SONET rings and provides an alternate path for the SONET signals in case of equipment failure. This feature is commonly known as signal protection.

The drop and repeat node is capable of splitting the SONET signal and sending copies of bytes onto two or more output links. The devices may be used to connect DSL devices for residential video (or even voice) services. The ADM SONET hub provides a high-speed optical connection (e.g., OC-48, OC-192 or higher) to other parts of the network, e.g., connection between local carriers and long distance carriers.

Each of the network elements 50 through 90, within its respective SONET layer, may include one or more of the SONET node functionalities. For example, network element 50 is shown to include the terminal multiplexor functionality in its SONET layer 92; network element 52 includes add/drop multiplexor in its SONET layer 96; network element 60 includes the digital cross-connect system node functionality in its SONET layer 100; network element 70 includes an ADM SONET hub in its SONET layer 106; network element 74 includes matched node functionality in its SONET layer 110; and network element 84 includes the drop and repeat functionality in its SONET layer 114. While each SONET layer is shown to include only one SONET physical layer function, one of average skill in the art will appreciate that each network element may include up to all of the SONET physical layer functions.

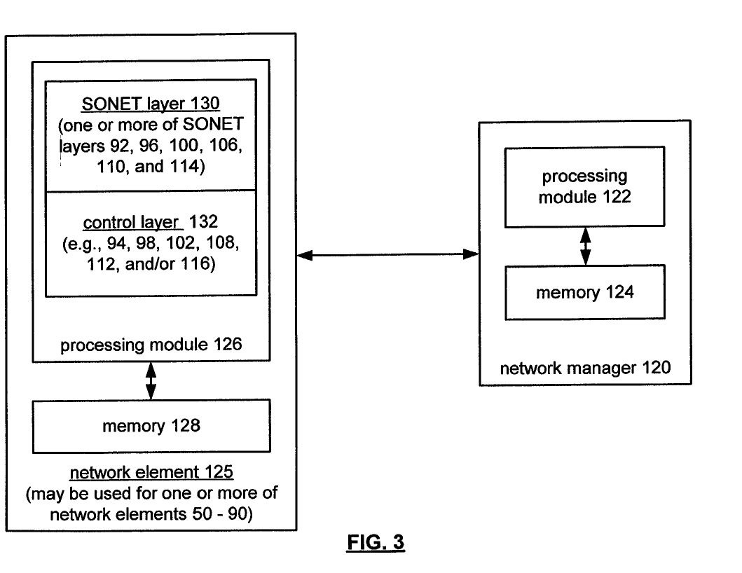

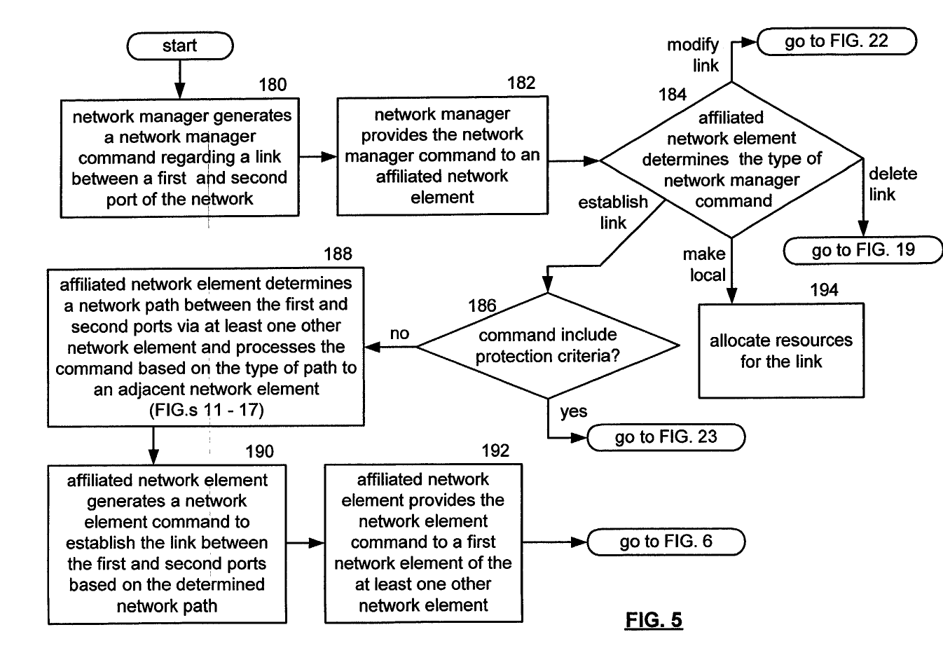

Each control layer of each network elements 50 through 90 (e.g., control layers, 94, 98, 102, 108, 112 and 116 for network elements 50, 52, 60, 70, 112, and 116, respectively) includes firmware (i.e., software and hardware) that enables the network element to perform the functions illustrated in FIGS. 5 through 36. The firmware will be described in greater detail with reference to FIG. 3.

FIG. 3 illustrates a schematic block diagram of a network element 125 operably coupled to a network manager 120. The network manager 120 includes a processing module 122 and memory 124. The processing module 122 may be a single processing device or a plurality of processing devices. Such a processing device may be a digital signal processor, microcontroller, microcomputer, central processing unit, state machine, logic circuitry, application specific integrated circuit (ASIC), programmable gate array, and/or any device that manipulates signals (analog or digital) based on operational instructions. The memory 124 may be a single memory device or a plurality of memory devices. Such a memory device may be a read-only device, random access memory device, flash memory, system memory, electronically erasable programmable read only memory (EEPROM), and/or any device that stores digital information. Note that when the processing module 122 implements one or more of its functions via a state machine or logic circuitry, the memory storing the corresponding operational instructions is embedded in the circuitry comprising the state machine or logic circuit. The operational instructions stored in memory 124 and executed by processing module 122 will be discussed in greater detail with reference to FIGS. 5 through 10, 18, and 30 through 36.

The network element 125 includes processing module 126 and memory 128. Processing module 126 may be a single processing device or a plurality of processing devices. Such a processing device may be a microprocessor, microcontroller, digital signal processor, central processing unit, programmable gate array, state machine, logic circuitry, ASIC, and/or any device that manipulates signals (analog or digital) based on operational instructions. The memory 128 may be a single memory device or a plurality of memory devices. Such a memory device may be read-only memory, random access memory, flash memory, system memory, magnetic tape memory, EEPROM, and/or any device that stores digital information. Note that when the processing module 126 implements one or more of its functions via a state machine or logic circuitry, the memory storing the corresponding operational instructions is embedded within the circuitry comprising the state machine or logic circuit.

The processing module 126, based on the operational instructions stored in memory 128, functions as a SONET physical layer 130 and a control layer 132. The SONET physical layer 130 may include one or more of SONET layers 92, 96, 100, 102, 110 or 114. In particular, the network element 125 may function as a terminal multiplexor, add/drop multiplexor, digital loop carrier, digital cross-connect, matched node, drop and repeat node, and/or a ADM SONET hub.

The control layer 132, which may be representative of control layer 94, 98, 102, 108, 112, and/or 116, enables the network element to provide automation to the processing of physical layer communication links. Each of the control layer 132 may use a label switching and/or a multi-protocol label switching (MPLS) technique to enable the network elements 125 to communicate link command information (e.g., network manager commands and/or network element commands) with each other. As is known, MPLS is a method for speeding up IP based data communications over networks. In general, MPLS works as a data stream enters the edge of the network at an ingress label switch router (LSR), which reads the full address of the 1^{st} data packet and attaches a small label in the packet header, which precedes the packet. Label edge switches (e.g., MPLS capable ATM switches) in the core of the network examine the much abbreviated label and switch the packet with much greater speed than if they were forced to consult programmed routing tables associated with the full IP address. All subsequent packets in a data stream are automatically labeled in this fashion and very quickly as they have been anticipated.

Further, the MPLS tag can be used to determine the most appropriate route, or label switch path for the down stream, in consideration of its nature and its explicit request for a different grade of service. All packets that are forwarded in the same manner are known as a Forwarding Equivalent Class (FEC). MPLS integrates OSI layer 2 (data link layer) and layer 3 (network layer) with the result being simplified and improved data packet exchange within a complex packet data network, such as the Internet. Accordingly, by utilizing MPLS, or another label switching concept, link command information may be readily exchanged between network elements of the network 12 to automate the processing of the physical layer to establish, delete, and/or modify communication links. The operational instructions stored in memory 128 and executed by processing module 126 will be discussed in greater detail with reference to FIGS. 5 through 36.

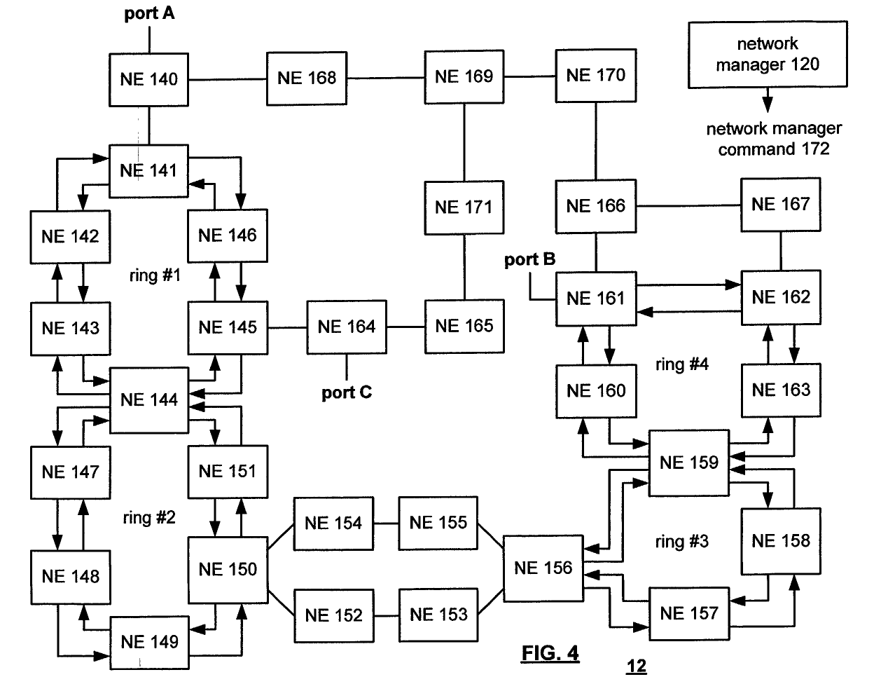

FIG. 4 illustrates a schematic block diagram of a plurality of network elements 140-171 and a network manager 120 of the communication network 12 that may support a plurality of communication links. For example, the plurality of network elements 140-171 and the network manager 120 may support a communication link between port A and port B, between port A and port C, and/or between port B and port C. Such a communication link may be a dedicated link for a particular customer or a temporary communication link. As one of average skill in the art will appreciate, each of the network elements 140-171 may include the functionality of network element 125 of FIG. 3 and may further include functionality to interface with substantially more network elements than shown. In addition, each network element may include a plurality of lines (e.g., OC-3, OC-12, OC-48, etc.) coupling it to a plurality of other network elements.

In this example, network elements 140, 161 and 164 include at least the SONET layer function of being a terminal multiplexor to support ports A, B, and C, respectively. As used herein, a port is a connection to an entity (e.g., a DLC 14 or 16, a RFT 18 or 20) outside of the SONET communication network 12. Network elements 141, 144, 150, 156, 159, 161, and 162 each include at least the SONET layer function of being an add/drop multiplexor since they are at the start or end of a SONET ring (e.g., ring #1, ring #2, ring #3, and ring #4). Network elements 152 through 155 include at least the SONET layer functionality of being a matched node. The remaining network elements include one or more of the SONET layer function of terminal multiplexor, add/drop multiplexor, digital cross-connect system, add/drop SONET hub, match node, and drop and repeat node.

Network elements 141 through 146 form a SONET ring (Ring #1). As is known, a SONET ring provides redundancy for protection for communication links. For example, Ring #1 may be established as a bi-directional line switched ring (BLSR) to include a working path and a backup path. Data is transmitted over the working path in halves, where one half of the bandwidth of each optical fiber is reserved for protect traffic. Another example of a SONET ring is unidirectional path switched ring (UPSR), which also includes a working path and a back-up path. In a UPSR ring, all of the data is transmitted in the working path over one fiber optic line in one direction and the other fiber optic line simultaneously transmits the data in the opposite direction as the backup path. For either type of SONET ring, if the working path fails, the back-up path carries the traffic.

Network elements 144, 147 through 151 form another SONET ring (Ring #2). Network elements 156 through 159 form another SONET ring (Ring #3). Network elements 159 through 163 form yet another SONET ring (Ring #4). Rings #2, #3, and #4 may utilize a BLSR redundancy or a UPSR redundancy to provide the desired protection.

In operation, to establish a communication link between two ports in the SONET communication network 12, the network manager 120 issues a network manager command 172 to establish the communication link. To establish a communication link, one of the network elements 140-171 receives the network command 172 from the network manager 120. Typically, the network manager command 172 will be received by a network element coupled to the network manager and may support one of the ports of the communication link (i.e., an affiliated network element). In this example, assume that network element 140 is operably coupled to the network element 140 and supports Port A, while network element 161 supports Port B. Once the affiliated network element (e.g., network element 140) has received the network manager command 172 via its control layer, it determines the type of command and begins to establish the communication link between Port A and Port B, which may be referred to as nodes.

For example, assume that network element 140 has received the network manager command 172 to establish a communication link between Port A and Port B. In this discussion, a communication link refers to a dedicated or non-dedicated transmission path that has been requested by a consumer of a service provider. Upon receiving the network manager command 172, network element 140 determines whether the command includes protection criteria. If so, the network element determines the type of protection for the link. If the protection criteria is to provide a fully protected link between Port A and Port B, the network element 140 determines an optimal path from Port A to Port B utilizing a Dykstra routine, or similar type algorithm, taking into account the protection requested.

In the present illustration of FIG. 4, a protected path from Port A to Port B would include Rings #1, #2, #3 and #4 and network elements 152 through 155. If protection is not required, network element 140 would determine the optimal path to network element 161 using the Dykstra routine based on the criteria provided in the network manager command (e.g., quality of service, latency, etc.). In this illustration, the path would be through network elements 168, 169, 171, 166, and 161.

Having determined the optimal path between Port A and Port B, network element 140 generates a network element command to continue the establishment of the link between Port A and Port B. Depending on whether the path is protected or not, network element 140 passes the network element command to the adjacent network element. For the protected path, network element 140 passes the network element command to network element 141. For the non-protected path, network element 140 passes the network element command to network element 168. In addition to generating the network element command, network element 140 would allocate, or reserve resources for the communication link between Port A and Port B.

Once the adjacent network element (for this example, network element 141 or 168), receives the network element command from 140, it determines whether it is the termination node, or termination multiplexor, for Port B. In this example it is not, so the adjacent network element allocates, or reserves, resources for the communication link between Port A and Port B and generates a network element command to continue the establishment of the communication link between Port A and Port B. As used herein, the term resource refers to all of the necessary means that a SONET element needs to reserve to establish and support a communication link.

For example, the resources include all of the relevant frame information such as, channel and time slots as well as determination of which fiber optic coupling the particular link is supported. As one of average skill in the art will appreciate, each network element may include a plurality of OC-3, OC-12, OC-48, et cetera fiber optic cables coupled thereto to provide the interconnection to other network elements. As such, resources include the identity of the particular fiber optic cable, which supports the particular frame, channel, and time slot that this particular communication link will be assigned.

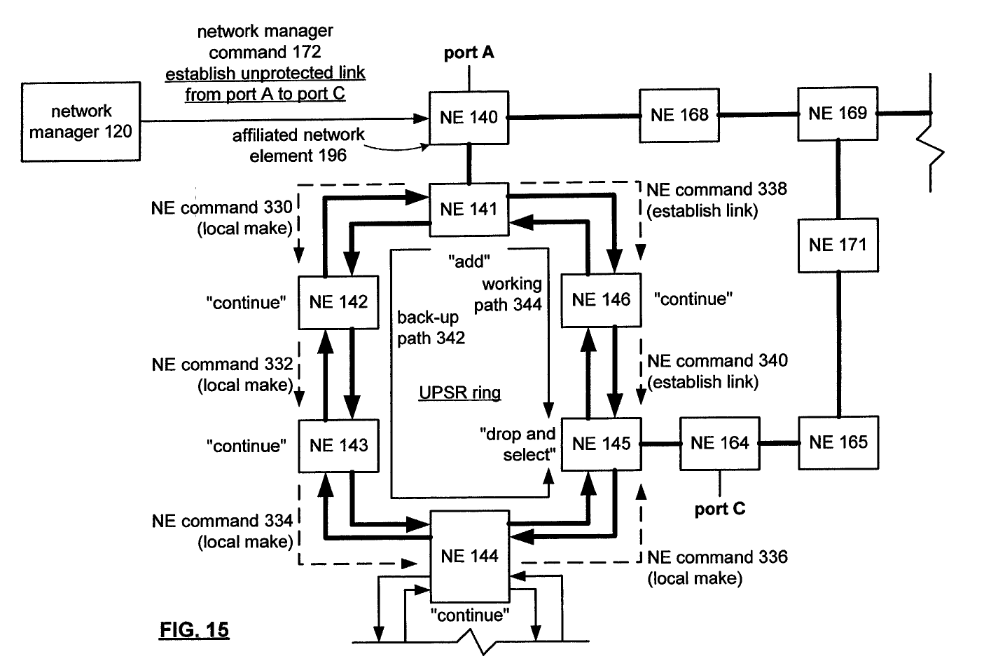

Network element 141 in addition to establishing a network element command establishes Ring #1 utilizing SONET techniques. The establishment of Ring #1 will be discussed in greater detail with reference to FIGS. 14 and 15. Once network element 141, or network element 168 have generated their respective network element command, it is passed to the next adjacent network element in the optimal path between Port A and Port B. Each network element in the path performs similar functions in that it determines whether it is the termination node and if not, allocates resources to support the communication link, generates a network element command to continue the establishment of the communication link between Port A and Port B, and then passes the network element command to the next adjacent network element in the path.

Once network element 161 receives the network element command to establish the link between Port A and Port B, it determines that it is the termination node. At this point in time, network element 161 allocates resources to support the communication link between Port A and Port B and generates an acknowledgment of establishing the communication link. Network element 161 provides the acknowledgment signal to the adjacent network element from which it received the network element command to establish the link. Each network element in the path between Port A and Port B upon receiving the acknowledgment converts the reserved resources into assigned resources to support the communication link between Port A and Port B and generates an acknowledgment signal which is propagated to the previous adjacent network element in the path. Each network element in the path performs the same function, i.e. converting the reservation of resources into assignment of resources to the communication link, generating the acknowledgment signal, and propagating the acknowledgment signal to the previous network element.

Once network element 140 receives the acknowledgment signal, it converts the reservation of resources into an assignment of resources for the communication link between Port A and Port B. In addition, network element 140 provides an acknowledgment signal to network manager 120 indicating that the communication link has been established. In this manner, network manager 120 issues a single command to establish a communication link. This is a vast improvement over the prior art where the operator of the network manager had to interface with each network element in the desired communication link to establish such a communication link.

To further facilitate the processing of link commands (e.g., network manger commands, network element commands, establish a link, modify a link, or delete a link), each network element includes a unique identification code or address. In addition, each network element includes a table of the network element addresses and identity of each network element each network element is coupled to. As such, each network element, via its control layer, includes a complete, or near complete list, of the construct of the SONET communication network 12.

FIG. 5 illustrates a logic diagram of a method for processing a network manager command in a communication network. The process begins at Step 180 where a network manager generates a network manager command regarding a link between a 1^{st} port and a 2^{nd} port of the network. The network manager command may be to establish a link, modify an existing link, delete an existing link, and/or make a local connection between two network elements. In addition, the network manager command may include link criteria such as, quality of service, transmission latencies, privacy, and link failure protection. The process then proceeds to Step 182 where the network manager provides (i.e., sends) the network manager command to an affiliated network element. As is known, a network manager may be operable coupled, i.e. affiliated, with a plurality of network elements in the communication network 12. For example, referring to FIG. 4, when the network manager 120 is establishing a communication link between Port A and Port B, it determines that network element 140 is a terminal multiplexor for Port A and hence identifies it as the affiliated network element. Alternatively, the network manager 120 may determine that network element 161 is the affiliated network element since it is the terminal multiplexor for Port B. In either case, the network manager provides the network manager command to the affiliated network element.

The process then proceeds to Step 184 where a determination is made by the affiliated network element as to what type of network manager command has been received. If the network manager command is to make a local connection between network elements, the process proceeds to Step 194 where the affiliated network element allocates resources to support the communication link. Recall that resources include, but is not limited to, the identity of the particular fiber optic cable coupling the network element to outside the network or to another network element, the channel assignment, the time slot(s) and/or any other coupling information to support a communication link in the network. Once the resources are allocated, the process is complete for this network element. Note that when the network manager is issuing a make local command, the network manager provides it to each network element in the desired communication link.

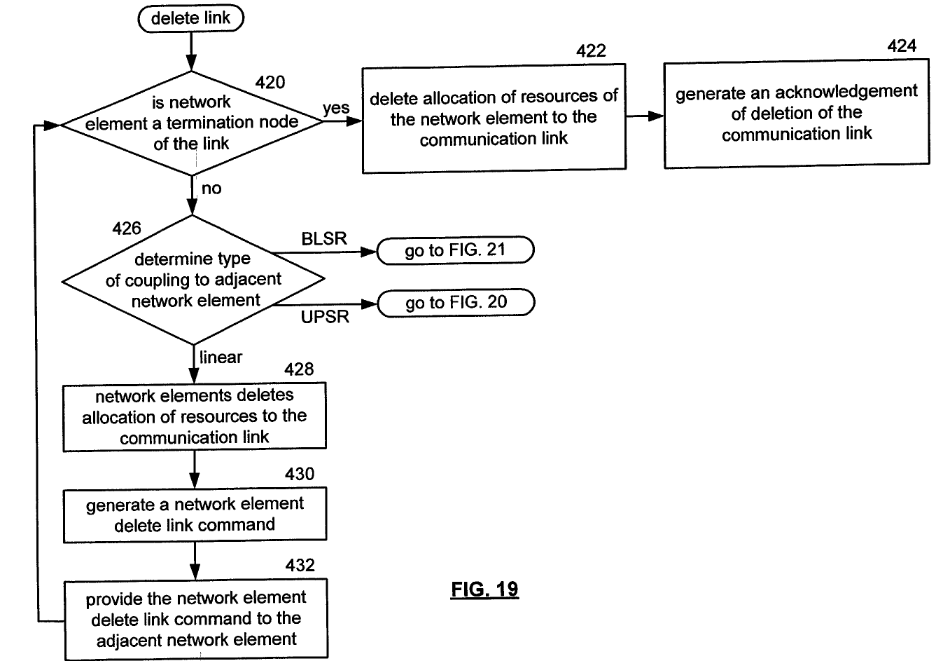

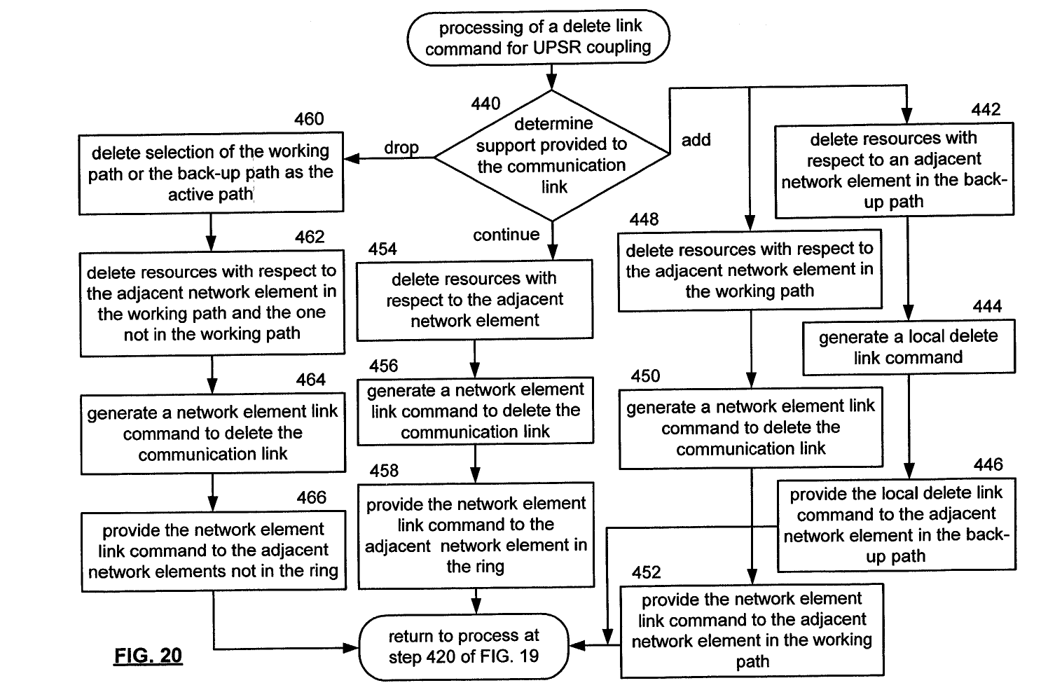

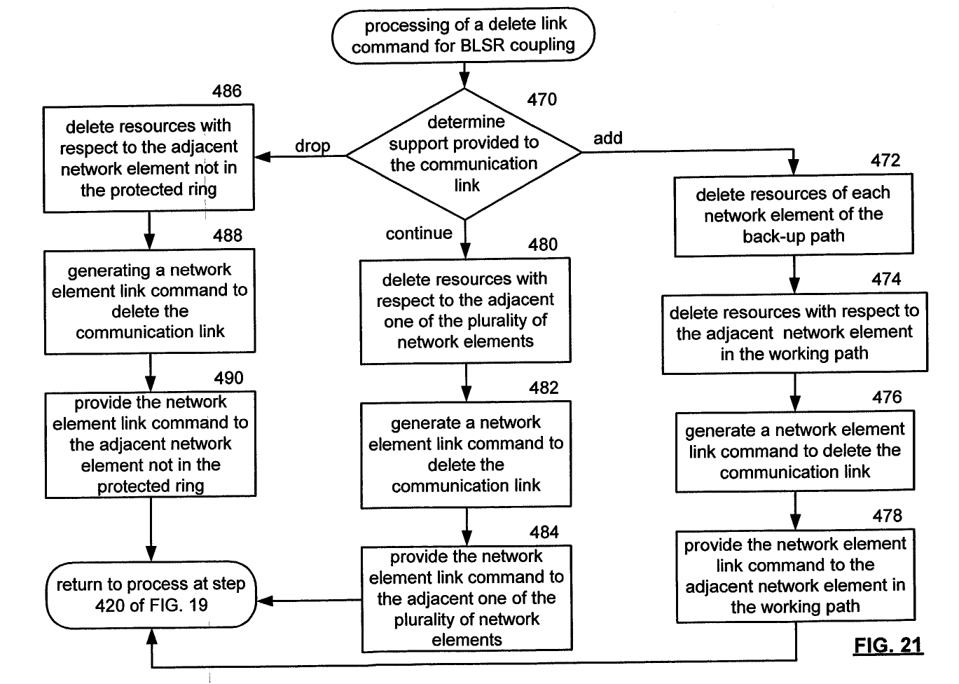

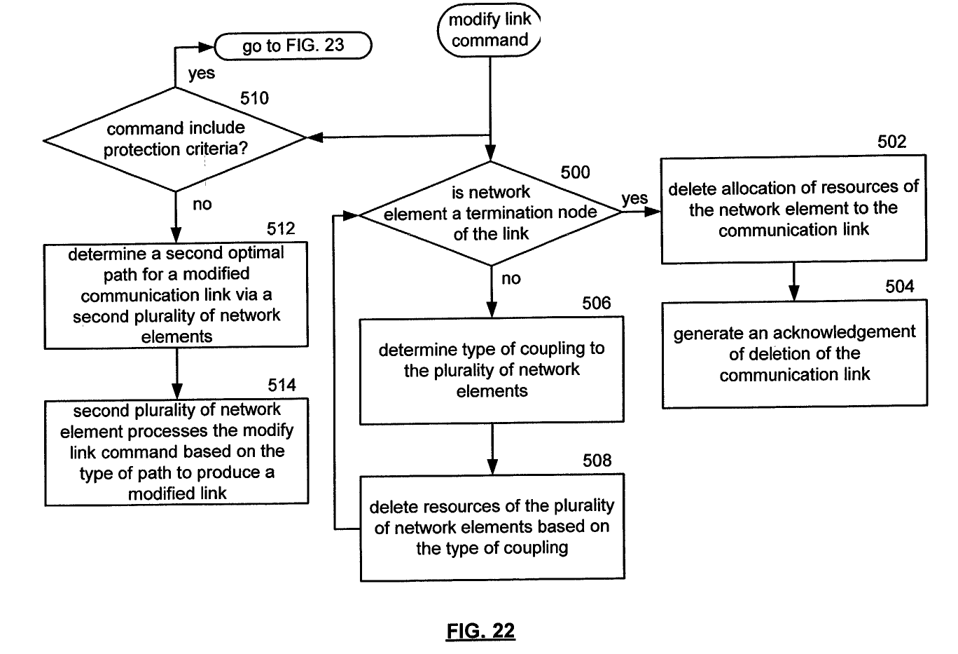

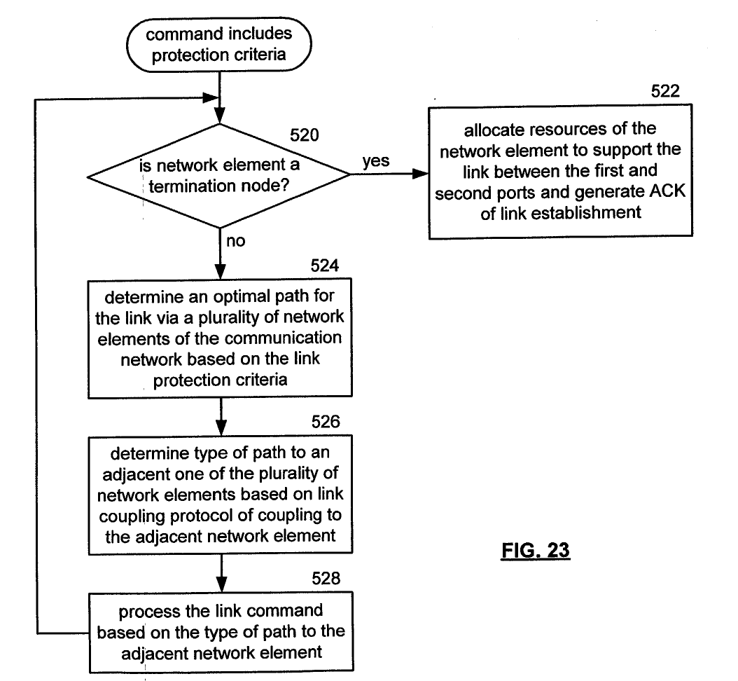

If the network manager command indicates that an existing link is to be modified, the affiliated network element will process the modify command as described in FIG. 22. If the network manager command is to delete an existing link command, the affiliated network element will process it in accordance with the logic diagram of FIG. 19. If the network manager command is to establish a communication link, the process proceeds to Step 186. At Step 186 a determination is made as to whether the network manager command includes protection criteria. If so, the process proceeds to the logic diagram as shown in FIG. 23.

If the network element command is to establish a link and it does not include protection criteria, the process proceeds to Step 188. At Step 188, the affiliated network element determines a network path between the 1^{st} and 2^{nd} ports of the requested communication link via at least one other network element. To determine the network path, the network element executes a Dykstra routine, or similar process, to determine the optimal path based on the criteria contained within the network manager command. For example, if the network manager command includes a specific quality of service, latency, and/or privacy, the network element determines the optimal network path between Port A and Port B based on these factors. Since these are known techniques, no further discussion of the Dykstra routine will be provided except to illustrate the concepts of the present invention.

Having determined the optimal path between the 1^{st} and 2^{nd} ports, the affiliated network element processes the network manager command based on the type of path to an adjacent network element of the path. The processing of the command will be discussed in greater details with reference to FIGS. 11 through 17.

The process then proceeds to Step 190 where the affiliated network element generates a network element command to continue the establishment of the communication link between the 1^{st} and 2^{nd} ports. The network element command will include the same link criteria as in the network manager command plus MPLS type routing information. The process then proceeds to Step 192 where the affiliated network element provides the network element command to a 1^{st} network element of the at least one other network element. In essence, the affiliated network element is providing the network element command to an adjacent network element in the identified path between Port A and Port B. Referring back to FIG. 4 as an example, network element 140 provides the network element command it generated to network element 168 when the path between Port A and Port B is via network elements 140, 168, 169, 170, 166 and 161.

The processing continues as shown in FIG. 6 where, at Step 220, the next adjacent network element receives the network element command. For example, in FIG. 4 when the path between Port A and Port B is via network elements 140, 168 through 170, 166 and 161, network element 168 is the next network element for network element 140 while network element 169 is the next network element for network element 168, et cetera.

The process then proceeds to Step 222 where the network element determines the type of network element it is to be for this particular communication link. If the network element is a termination network element, or termination node, the process proceeds to Step 224 where the network element allocates its resources to support the communication link between the 1^{st} and 2^{nd} ports. In addition, the network element generates an acknowledgment of establishment of the communication link. The acknowledgment is propagated back to the affiliated network element. As each network element in the communication path receives the acknowledgment signal, it converts the reserved resources into assigned resources. In addition, the network element generates its own acknowledgement signal and provides it to the preceding network manager. The assigning of resources and generating an acknowledgement signal continues until the affiliated network elements receive the acknowledgement signal. At this point, the affiliated network converts its reserved resources into assigned resources and provides the acknowledgement signal to the network manager 120. Once the communication link has been established, the network manager can enable a customer to utilize the link.

If, at Step 222, the network element is a supporting network element or node, the process proceeds to Step 226. At Step 226, the network element determines the type of command. If the command is a modify link, the processing continues at FIG. 22, if it is a delete link command, the process proceeds at FIG. 19. If the command is to make a local connection, the process proceeds to Step 234 where the network element allocates, or assigns, resources for the communication link. Once the resources have been allocated, the process for this particular network element is complete.

If the type of command is to establish a communication link, the process proceeds to Step 228. At Step 228, the network element determines a network path, utilizing a Dykstra routine, between itself (i.e., the current network element) and the 2^{nd} port. The path may include another adjacent network element. Having determined the continuing network path, the network element processes the command based on the type of path to the adjacent network element. The processing of a command based on the type of path will be discussed in greater detail with reference to FIGS. 11 through 17.

The process then proceeds to Step 230 where the network element generates a network element command to continue the establishment of the link between the 1^{st} and 2^{nd} ports. The network element command will include all the criteria of the original network manager command such as quality of service, latencies, privacy, et cetera. The process then proceeds to Step 232 where the network element provides the network element command to another network element in the identified path between the 1^{st} and 2^{nd} ports. At this point, the process repeats at Step 220 for the next network element in the path. As such, each network element in the identified communication path will perform the functional operations as shown in FIG. 6 to establish the communication link between the 1^{st} and 2^{nd} ports. Accordingly, the network manager issues a single command to a single network element, which causes a communication link within the system to be automatically established, modified, and/or deleted.

FIG. 7 illustrates a schematic block diagram of an example of establishing a communication link between Port A and Port B of FIG. 4 utilizing the processing of FIGS. 5 and 6. As shown, a network manager 120 issues a network manager command 172 to an affiliated network element 196. In this example, the affiliated network element 196 is network element 140. The network manager command 172 indicates that an unprotected link is to be established between Port A to Port B. Upon receiving the network manager command 172, network element 140 performs the processing steps 182 through 192 of FIG. 5. As such, network element 140 identifies a plurality 200 of network elements that form an optimal path between Port A and Port B to support an unprotected link. In addition, the network element 140 processes the network manager command 172, as will be described in greater detail in FIGS. 11 through 17, to reserve resources to support the communication link between Port A and Port B. Further, network element 140 generates a network element command 204 to continue the establishment of the unprotected link from Port A to Port B.

In this example, network element 168 is a supporting link element 208 and is also the 1^{st} network element 202 in the plurality 200 of network elements. As such, network element 168 performs the processing Steps of 220 through 232 of FIG. 6. In this example, network element 168 is a supporting link element thus it reserves resources to support the communication link from Port A to Port B (the allocation of resources will be described in greater detail with reference to FIGS. 11 through 17) and generates a network element command that is provided to the next network element in the plurality of network elements forming the optimal path between Port A and Port B.

The next network element in the unprotected network path 198 is network element 169. Network element 169 performs the processing steps 220 through 232 of FIG. 6 to reserve resources for the communication link and generates a network element command. In turn, network elements 170 and 166 also perform the processing Steps 220 through 232 of FIG. 6. Network element 166 provides its network element command to network element 161, which performs the processing Steps 220 through 224 of FIG. 6. In this illustration, network element 166 is a termination link element 206 for the communication link between Port A and Port B. Having determined that network element 161 is the termination node for this particular communication link, it allocates, or assigns, its resources to support the communication link. At this point, the resources are dedicated to this particular communication link. Network element 161 then generates an acknowledgment 210 indicating that the link has been established.

The acknowledgment 210 is provided to network element 166. Network element 166 converts the reservation of resources to an allocation of resources and generates a similar acknowledgment signal. The acknowledgment signal is propagated back to network element 140 where each network element in the plurality 200 of network elements converts the reservation of resources into allocation of resources and generates an appropriate acknowledgment signal. Once network element 140 receives the acknowledgment signal, it converts the reservation of resources into allocation of resources and provides the acknowledgment to network manager 120. As one of average skill in the art will appreciate, the network manager 120 may have issued the network manager command 172 to network element 161 where network element 161 would be the affiliated network element 196 and network element 140 would be the termination link element 206.

FIG. 8 illustrates an alternate method for processing a network manager command in a communication network. The process begins at Step 240 where a network manager provides a network manager command regarding a link between a 1^{st} port and a 2^{nd} port of the network to one of a plurality of network elements. The network manager command may include link criteria such as, quality of service, transmission latencies, privacy and/or link failure protection.

The process proceeds to Step 242 where the network element receiving the network manager command determines the type of network manager command. If the network manager command is to make a local connection, the process proceeds to Step 244 where the network element allocates resources for the particular link. At this point, the process is complete for this particular network element. If the type of network manager command is to modify an existing communication link, the process proceeds to the logic diagram of FIG. 22. If the type of network manager command is to delete an existing link, the process proceeds to the logic diagram of FIG. 19.

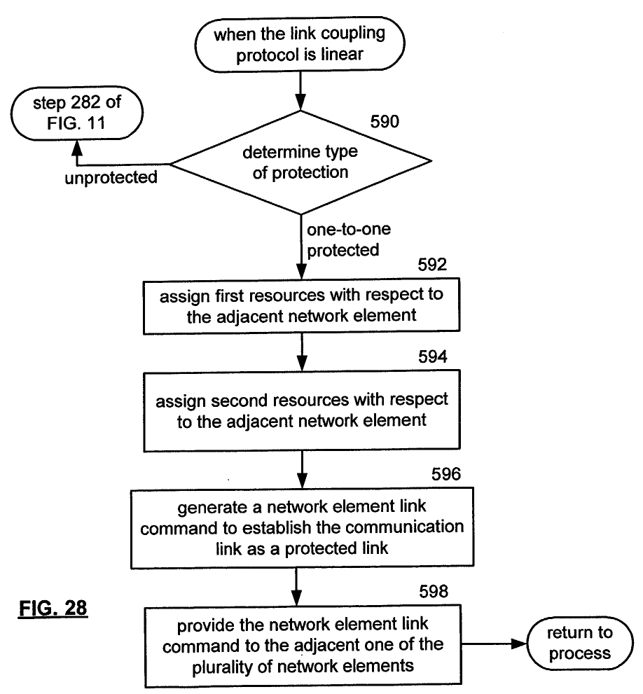

If the type of network manager command is to establish a new communication link, the process proceeds to Step 246. At Step 246 the plurality of network elements processes the network manager command. Such processing will be further described with reference to FIG. 18 and/or FIG. 29.

The process then proceeds to Step 248 where one of the plurality of network elements provides an acknowledgment of processing of the network manager command to the network manager. The process then proceeds to Step 250 where the network manager receives the acknowledgment. Upon receiving the acknowledgment, the network manager enables usage of the link by a customer that had requested the communication link.

FIG. 9 illustrates a logic diagram of a further alternate method for processing a network manager command in a communication network. The process begins at Step 260 where a network manager generates a network manager command regarding a link between a 1^{st} port and a 2^{nd} port of the network. The network manager command may include link criteria such as quality of service, transmission latencies, privacy and/or link failure protection. The process then proceeds to Step 262 where the network manager provides the network manager command to an affiliated network element. The process then proceeds to Step 264 where the affiliated network element determines whether it supports the 1^{st} or 2^{nd} port. If so, the process proceeds to Step 184 of FIG. 5 and follows the processing of FIGS. 5 and 6 from there.

If, however, the affiliated network does not support the 1^{st} or 2^{nd} port, the process proceeds to Step 266. At Step 266, the affiliated network element identifies a network element that supports the 1^{st} or 2^{nd} port. The affiliated network element may identify the network element that supports the 1^{st} or 2^{nd} port by accessing a lookup table to determine the identity of such a network element. Alternatively, the network manager command may include the identity of the network element that supports the 1^{st} or 2^{nd} port. The process then proceeds to Step 268 where the affiliated network element relays the network manager command to the identified network element.

The process then proceeds to Step 270 where the identified network element determines the type of network manager command. If the network manager command is to make a local connection, the process proceeds to Step 272 where the identified network element allocates resources to support the link. At this point, the process is complete for this particular network element. If the type of network manager command is to modify an existing link, the process proceeds to the logic diagram of FIG. 22. If the type of network manager command is to delete an existing link, the process proceeds to the logic diagram of FIG. 19. If the type of network manager command is to establish a link, the process proceeds to Step 274.

At Step 274, the identified network element determines a network path between the 1^{st} port and the 2^{nd} port via a plurality of network elements based on the network manager command. The process then proceeds to Step 276 where the plurality of network elements processes the network manager command to establish the link between the 1^{st} and 2^{nd} ports. Such processing will be further described with reference to FIGS. 18 and/or 29.

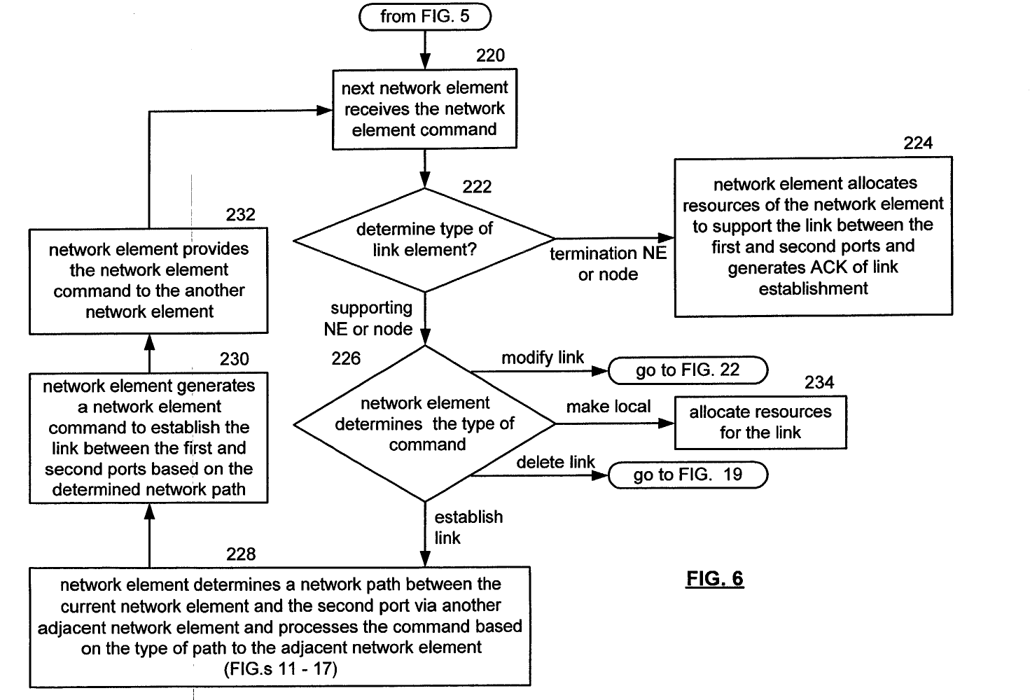

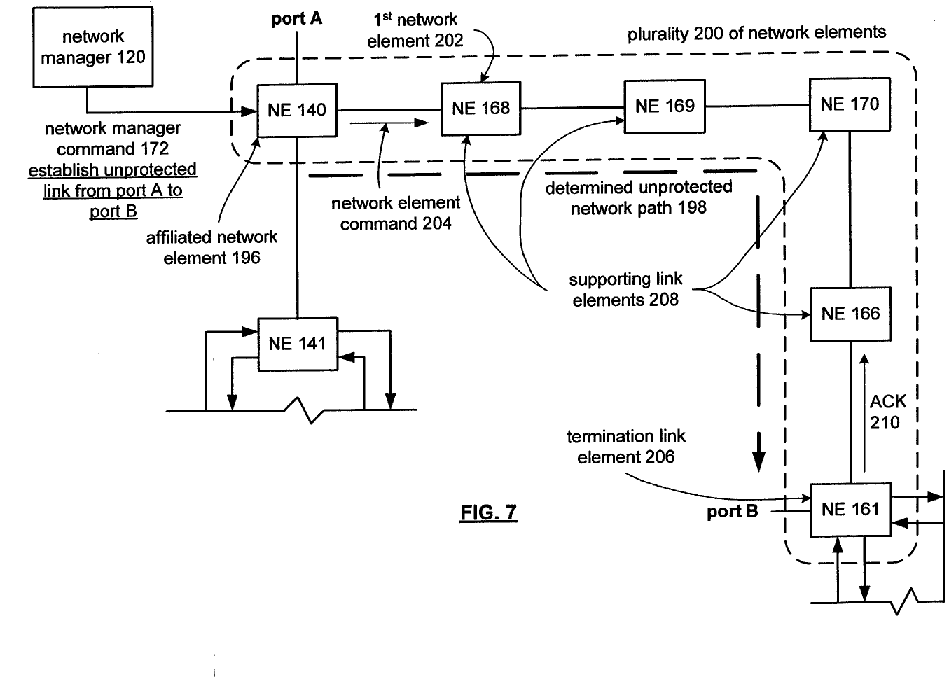

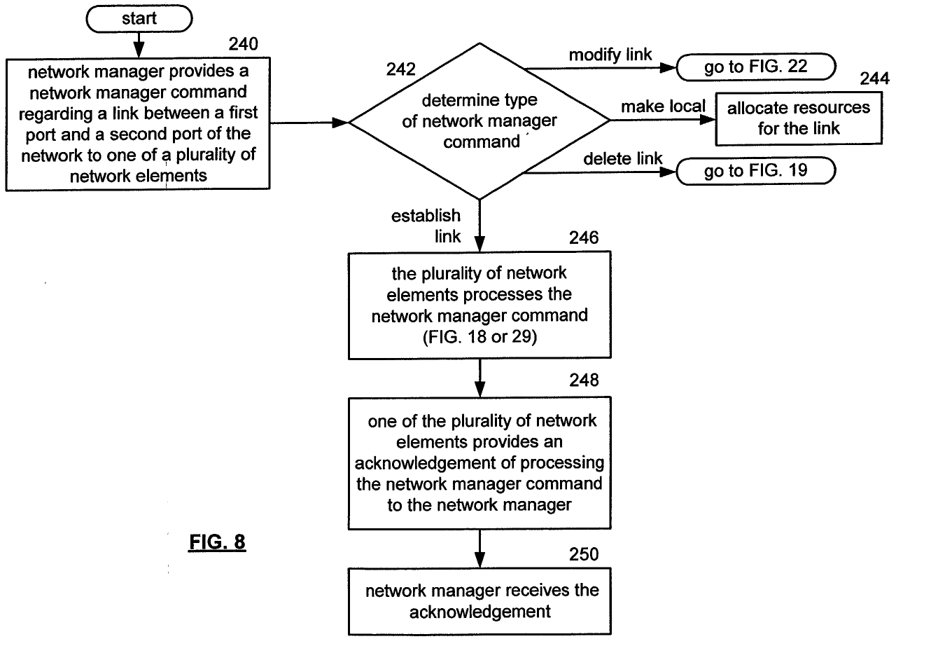

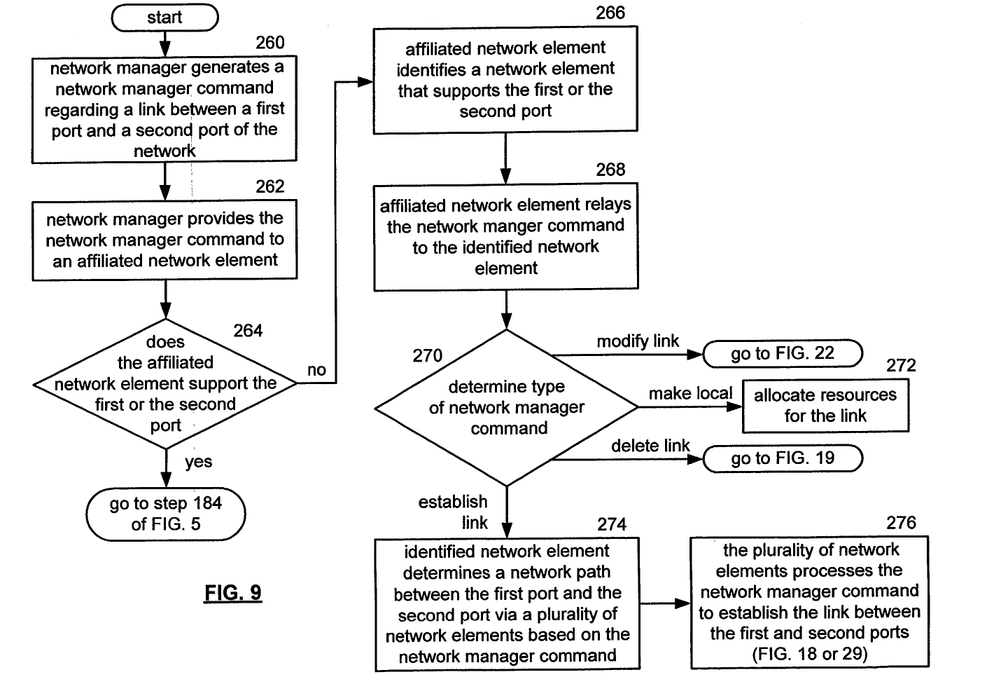

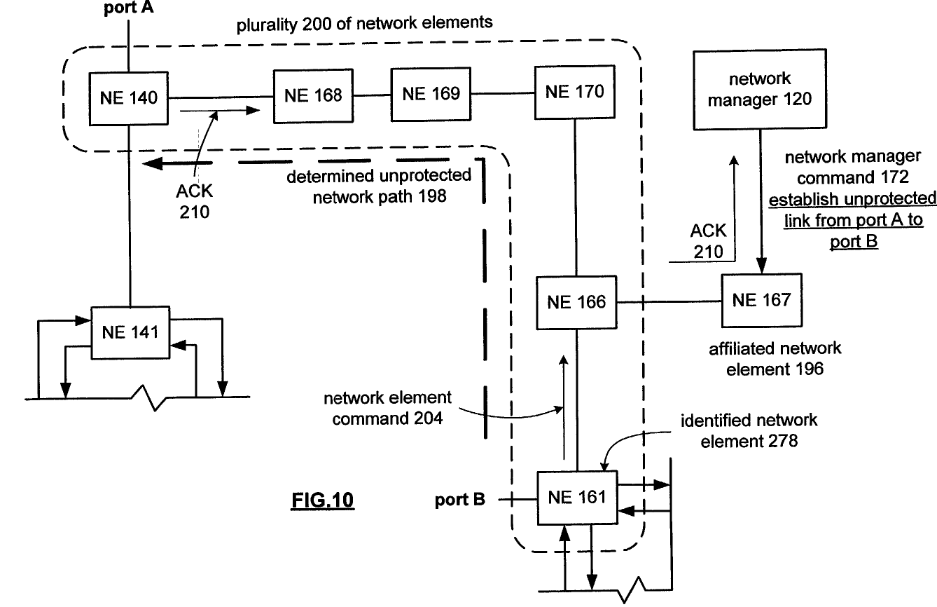

FIG. 10 illustrates a schematic block diagram that provides an example of the processing as shown in FIG. 9. In this example, network manager 120 generates a network manager command 172 to establish an unprotected link from Port A to Port B. In this illustration, network manager 120 does not have a direct connection to network element 140 or to network element 161. In this example, network manager 120 only has a direct connect path to network element 167. As such, for this example, network element 167 is the affiliated network element 196. Network element 167 interprets the network manager command 172 to identify a network element that supports either Port A or Port B. In this illustration, network element 167 identifies network element 161 as supporting Port B. As such, network element 161 is the identified network element 268. At this point, network element 167 provides the network manager command to network element 161, which reserves resources to support the communication link between Port A and Port B and generates a network element command. Network element 161 provides the network element command to continue the establishment of the link between Ports A and B and provide the command to network element 166. From here, the communication link is established via network elements 170, 169, 168, and 140 performing Steps 220 through 232 of FIG. 6.

Network element 140, which acts as the termination node for this particular unprotected network path 198, assigns resources for the communication link between Port A and Port B and generates the acknowledgment signal 210. The acknowledgment signal is propagated back to network element 161. At this point, network element 161 relays the acknowledgment signal through network element 166 to network element 167. At this point, network element 167 provides the acknowledgment signal to the network manager 120 indicating that the communication link has been established.

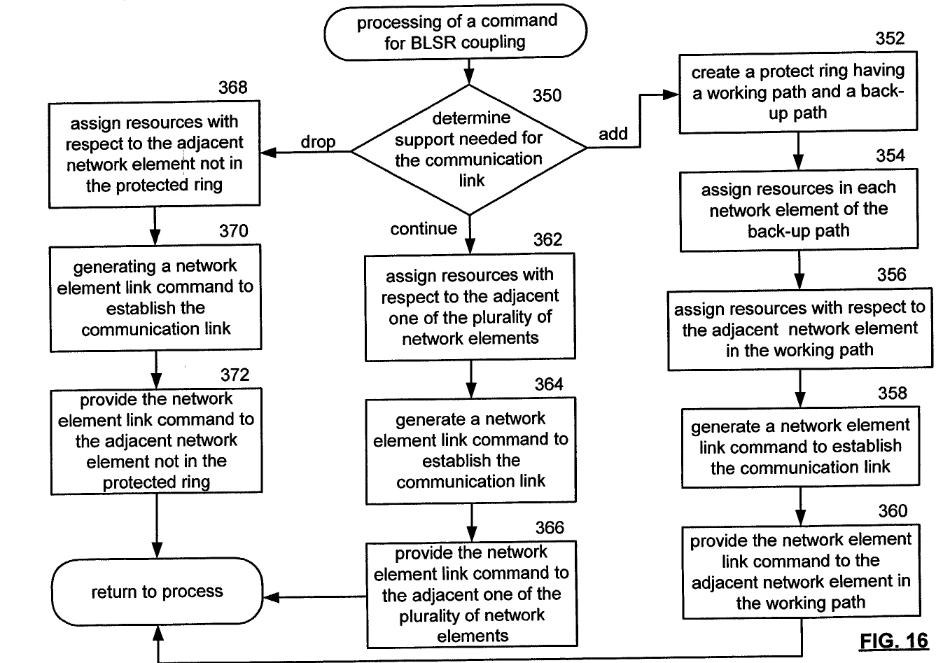

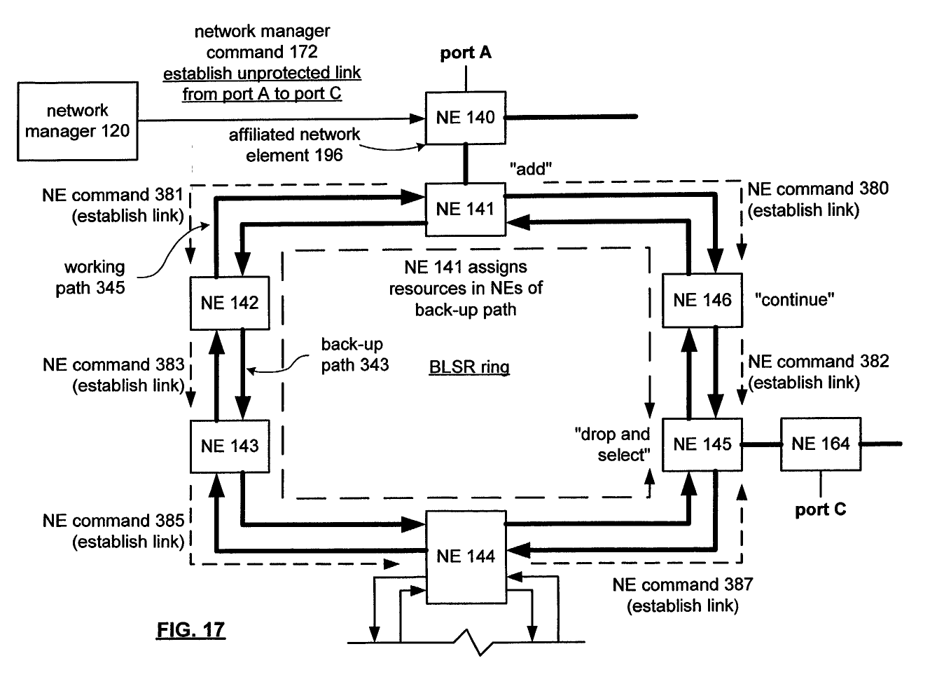

FIG. 11 illustrates the processing of a command based on the type of path as referenced in Step 188 of FIG. 5 and Step 228 of FIG. 6. The process begins at Step 280 where the network element determines the link coupling protocol of the coupling from the network element to an adjacent network element. If the link coupling protocol is a unidirectional path switched ring (UPSR), the processing continues as shown in FIG. 14. If the link coupling protocol is bi-directional line switched ring (BLSR,) the process proceeds to the logic diagram as shown in FIG. 16. If the link coupling protocol is linear, the process proceeds to Step 282. At Step 282, the network element assigns, or reserves, resources with respect to the adjacent one of the plurality of network elements. Once the resources have been assigned, the processing continues as previously described with reference to FIGS. 5 and 6.

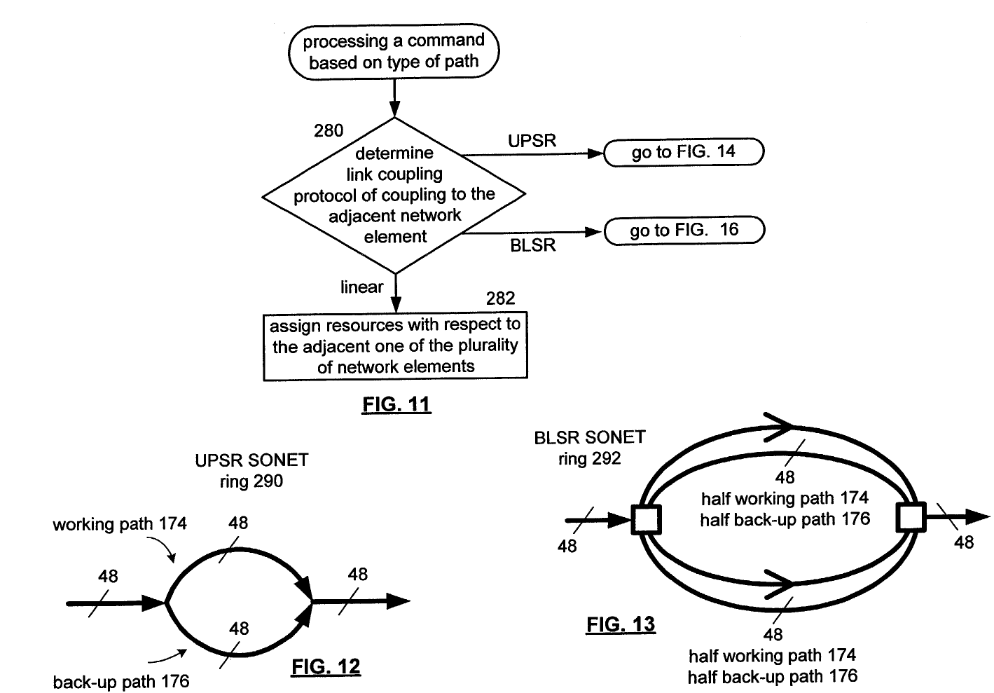

FIG. 12 illustrates a graphical representation of a unidirectional path switch ring (UPSR) 290. In this illustration, the bandwidth of the link entering the ring is 48 units. For example, the 48 units may be representative of an OC-48 link, an OC-12 ring, or any other optical coupling between network elements in a ring.

The ring includes a working path 174 and a backup path 176. During normal operations, the incoming data is all routed via the working path 174, while the backup path 176 remains idle but allocated to the ring 290. If a failure occurs in the working path 174, the traffic switches to the backup path 176.

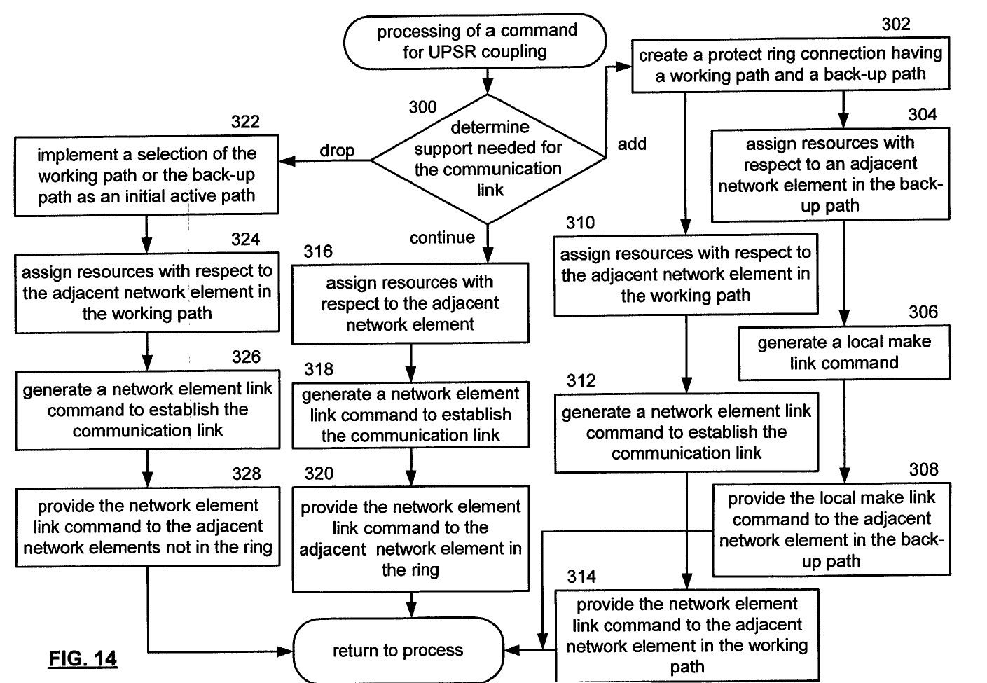

FIG. 13 illustrates a BLSR (bi-directional line switched ring) 292. As illustrated, the input link to the ring has a bandwidth of 48, which may be representative of an OC-12, OC-48 or any other optical coupling between network elements. For example, if the ring is an OC-48 ring, it is divided into halves, where one half of each path is dedicated to the working path 174 and the other half of each path is used for the backup path 176. In normal operation, the working path supports the traffic. If a failure occurs in the working path, the backup path bridges the failure to ensure that the data traffic continues to flow.

For either of the SONET rings 290 or 292, communication links supported by the rings 290 or 292 may have various levels of protection. Recall that each of the paths within the ring may be composed of an OC-48 link, OC-12 link, etc. Each link can support a plurality of communications. As such, some of the communications supported by the optical couplings may be of varying levels of protection. Such varying levels of protection include fully protected, unprotected/preemptable, and unprotected/non-preemptable.

In a fully protected communication link, the resources in the working path 174 and the corresponding resources in the backup path 176 are dedicated to a particular communication. Thus, if a failure occurs in the working path, the backup path becomes the active path.

For an unprotected/preemptable communication link, the unused resources in the backup path 176 are used by another communication link. If, however, a failure occurs in the working path 174 for a first communication, the use of the backup path by the other communication link is preempted for use by the first communication.

For an unprotected/non-preemptable communication link, the working path 174 is dedicated to one communication link and the backup path 176 is dedicated to another communication link. Thus, if a failure occurs in either the working path 174 or the backup path 176, the communication link is non-protected, i.e. it will cease to perform until the failure is corrected. As one of average skill in the art will appreciate, the various levels of protection are provided to the consumer at varying costs. A fully protected link costs more than an unprotected/non-preemptable link, which costs than an unprotected/preemptable link.

FIG. 14 illustrates a logic diagram for processing of a command wherein the link coupling protocol is UPSR. The process begins at Step 300 where the network element determines the type of support it needs to provide for supporting the communication link. The types of support include add, drop, and continue. Providing add support requires the network element to establish a UPSR ring, the continue support requires the network element to be part of the ring in the working path and/or the backup path, and the drop support requires the network element to drop the traffic to an adjacent network element not in the ring.

If the type of support needed is to add a UPSR connection, the process proceeds to Step 302. At Step 302, a protected ring having a working path and a backup path is created. The process then proceeds to Step 304 and to Step 310. At Step 304, the network element assigns resources with respect to an adjacent network element in the backup path. The process then proceeds to Step 306 where the network element generates a local make link command. The process then proceeds to Step 308 where the network element provides the local make link command to the adjacent network element to the backup path. Network elements in the backup path propagate the local make link command such that the resources in the backup path are allocated to the communication link.

At Step 310, the network element assigns resources with respect to the adjacent network element in the working path. The process then proceeds to Step 312 where the network element generates a network element link command to continue the establishment of the communication link. The process then proceeds to Step 314 where the network element link command is provided to the adjacent network element in the working path. Once the network element has provided the network element command to the adjacent network element the processing returns to the flow of FIG. 5, 6 and 11.

If the type of support needed is to continue the working path of a UPSR connection, the process proceeds to Step 316. At Step 316, the network element assigns resources with respect to the adjacent network element. The process then proceeds to Step 318 where the network element generates a network element link command to establish the communication link. The process then proceeds to Step 320 where the network element provides the network element link command to the adjacent network element in the ring. At this point, the processing returns to the flow of FIGS. 5 and 6.

If the support needed is to drop the link (or connection), the process proceeds to Step 322. At Step 322, the network element implements a selection of the working path or the backup path to act as the initial active path. The process then proceeds to Step 324 where the network element reserves resources with respect to the adjacent network element in the working path. The process then proceeds to Step 326 where the network element generates a network element link command to establish the communication link. The network element then provides the network element link command to the adjacent network element not in the ring. In addition, the network element may assign resources with respect to the network element not in the ring. At this point, the process returns to the flow of FIGS. 5 and 6.

FIG. 15 illustrates a schematic block diagram of an example of establishing a communication link between Port A and Port C of the network 12 of FIG. 4. In this example, the network manager 120 issues a network manager command 172 to establish an unprotected link between Port A and Port C. Network element 140 is the affiliated network element 196 and determines an optimal path between Port A and Port C. In this example, network element 140 could choose a path to Port C via network element 168, 169, 171, 165 and 164 or a path via network element 141, 146, 145 and 164. For the link criteria provided within the network manager command, network element 140 determines that the optimal path is via network elements 141, 146, 145 and 164. Since network elements 141, 146 and 145 are part of a UPSR ring, the communication link between Port A and Port C will include the ring.

Once the network element 140 has established the communication link, it provides a network element command to network element 141 to continue the establishment of the link. Network element 141 performs the processing steps of FIGS. 11 and 14 to add the UPSR ring to the link between Port A and Port C. Accordingly, network element 141 establishes that the backup path 342 includes network elements 142, 143 and 144. In addition, the network element 141 determines that the working path 344 includes network element 146 to network element 145.

Network element 141 generates a network element command 330 to make a local connection and generates network element command 338 to establish the link. The make a local connection network element command 330 is provided to the adjacent network element (e.g., network element 142) in the backup path 342. Network element 141 provides the established link command network element command 338 to the adjacent network element (e.g., network element 146) in the working path 344.

Network element 142 receives the network element command 330 to make a local connection. Accordingly, network element 142 allocates resources for the backup path and propagates network element command 332 to make a local connection. Network element 142 provides the network element command 332 to network element 143. The make local connection continues around the backup path 342 until it reaches network element 145.

Network element 146, upon receiving the network element command 338, assigns resources to the working path 344 and generates a network element command 340 to continue the establishment of the link.

Network element 145 receives the network element command 340 to establish the link and determines that it is a drop and select node. Accordingly, network element 145 performs the processing as shown in Steps 322 through 328 of FIG. 14. Accordingly, network element 145 allocates resources to support the communication ring and also allocates resources to interface with network element 164, which is not in the ring. In addition, network element 145 provides a network element command to continue the establishment of the link to network element 164. Network element 164, being a termination node for the communication link between Port A and Port C, performs the functions as shown in Steps 220 through 224 of FIG. 6.

FIG. 16 illustrates a logic diagram for processing a command based on a type of path when the path is a BLSR SONET ring. The process begins at Step 350 where the network element determines the type of support needed for the communication link. The types of support are: add a ring, continue establishment of the ring or drop the connection to a network element not in the ring. If the support needed is to continue the establishment of a ring, the process proceeds to Step 362. At Step 362, the network element assigns resources with respect to the adjacent one of the plurality of network elements (i.e. the adjacent network element in the ring). The process then proceeds to Step 364 where the network element generates a network element command to continue the establishment of the link. The process then proceeds to Step 366 where the network element provides the network element link command to the adjacent network element in the ring. At this point, the process returns to the processing of FIGS. 5 and 6.

If the support needed is to add a ring connection, the process proceeds to Step 352 where the network element creates a protected ring, or protected ring connection, having a working path and a backup path. The process then proceeds to Step 354 where the network element assigns resources in each network element of the backup path. The process then proceeds to Step 356 where the network element assigns resources with respect to the adjacent network element in the working path. The process then proceeds to Step 358 where the network element generates a link command to continue the establishment of the communication link. The process then proceeds to Step 360 where the network element provides the network element link command to the adjacent network element in the working path.

If the support needed is to drop the link to outside of the ring, the process proceeds to Step 368. At Step 368, the network element assigns resources with respect to the adjacent network element not in the protected ring. The process then proceeds to Step 370 where the network element generates a network element link command to establish the communication link. The process then proceeds to Step 372 where the network element provides the network element link command to the adjacent network element not in the protected ring. At this point, the processing returns to the processing as shown in FIGS. 5 and 6.

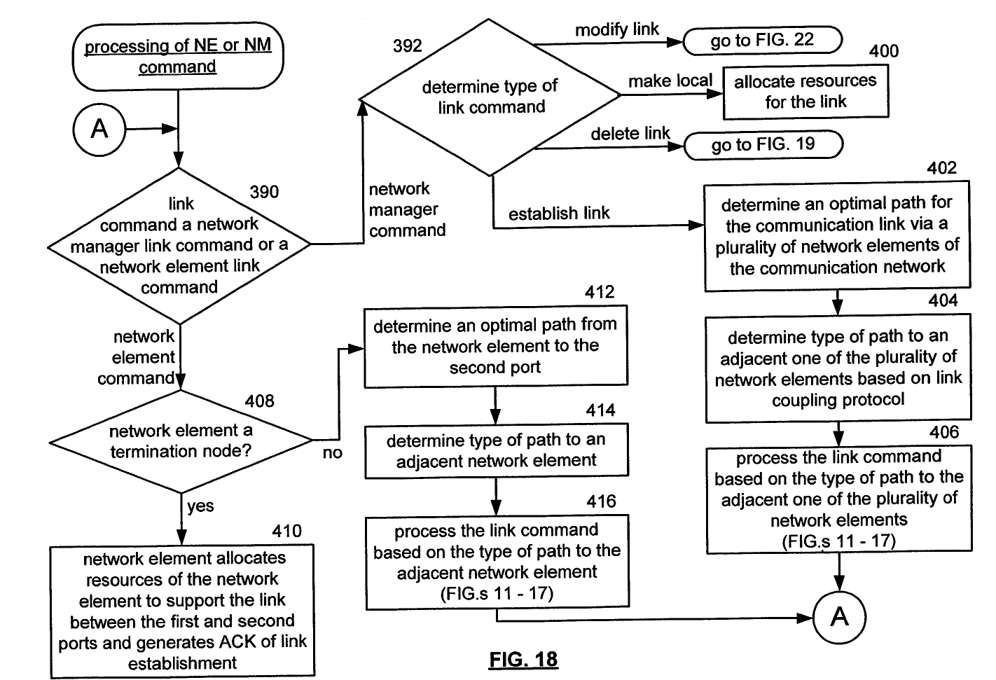

FIG. 17 illustrates a schematic block diagram, which is an example of the processing steps shown in FIGS. 11 and 16. In this example, network manager 120 issues a network manager command 172 to establish an unprotected link from Port A and Port C. Network element 140 is the affiliated network element 196. Network element 140 determines that the optimal path to network element 164, which supports Port C, is via the BLSR ring. The BLSR ring includes network elements 141, 142, 143, 144, 145 and 146. Network element 140 generates a network element command and provides it to network element 141.

Network element 141 receives the network element command from network element 140 and establishes the BLSR ring for the communication link between Port A and Port C. Network element 141 establishes the backup path 343 and the working path 345. For the backup path, network element 141 assigns resources in each network element of the backup path. For the working path, network element 141 generates a network element command 381 to establish the communication link. Each network element in the working path of the BLSR ring receives a network element command to establish the link, allocates resources to support the link and provides a network element command to an adjacent network element in the ring.

Once network element 145 receives the network element command 387 to establish the link, network element 145 functions as a drop node for this particular communication link. Accordingly, network element 145 generates a network element command and provides it to network element 164, which is not in the ring.

FIG. 18 illustrates a logic diagram of a method for processing a network element command or a network manager command. The process begins at Step 390 where a network element determines the type of link command to be either a network manager link command or a network element link command. When the link command is a network manager command, the process proceeds to Step 392. At Step 392, the network element determines the type of link command. If the type of link command is to make a local connection, the process proceeds to Step 400. At Step 400, the network element allocates resources to support the communication link and the process returns to normal flow. If the type of link command is to modify an existing link, the process proceeds to the logic diagram of FIG. 22. If the type of link command is to delete an existing link, the process proceeds to the logic diagram of FIG. 19.

If the type of link command is to establish a link, the process proceeds to Step 402. At Step 402, the network element determines an optimal path for the communication link via a plurality of network elements. The process then proceeds to Step 404 where the network element determines the type of path to an adjacent one of the plurality of network elements based on the link coupling protocol to the adjacent network element. The process then proceeds to Step 406 where the network element processes the link command based on the type of path to the adjacent one of the plurality of network elements. The processing of a link command based on the type of path was described with reference to FIGS. 11 through 17. At this point, the process repeats at Step 390.

If the type of link command is a network element command, the process proceeds to Step 408. At Step 408, the network element determines whether it is a termination node for the communication link. If so, the process proceeds to Step 410 where the network element allocates its resources to support the communication link. In addition, the network element generates an acknowledgment that the link has been established. The acknowledgment is then provided to the previous adjacent network element such that the acknowledgement signal is propagated back to the network manager.

If the network element is not a termination node, the process proceeds to Step 412. At Step 412, the network element determines an optimal path from the network element to the 2^{nd} Port. The process then proceeds to Step 414 where the network element determines the type of path to an adjacent network element. The process then proceeds to Step 416 where the network element processes the link command based on the type of path to the adjacent network element. The processing of a link command based on the type of path has been described with reference to FIGS. 11 through 17. At this point, the process repeats at Step 390.

FIG. 19 illustrates the processing of a network manager command that indicates that an existing communication link is to be deleted. The process begins at Step 420 where a network element determines whether it is a termination node for the link. If so, the process proceeds to Step 422 where the network element deletes allocation of resources that support the communication link. The process then proceeds to Step 424 where the network element generates an acknowledgment that the deletion of the communication link as been completed. This acknowledgment is propagated back through the network elements that made up the communication link until the network manager receives the acknowledgment that the link has been deleted.

If the network element is not a termination node, the process proceeds to Step 426. At Step 426, the network element determines the type of coupling to the adjacent network element. If the type of coupling is BLSR, the process proceeds to the logic diagram shown in FIG. 21. If the type of coupling is UPSR, the process proceeds to the logic diagram shown in FIG. 20. If the type of coupling is linear, the process proceeds to Step 428. At Step 428, the network element deletes allocation of resources to the communication link. The process then proceeds to Step 430 where the network element generates a network element delete link command. The process then proceeds to Step 432 where the network element delete link command is provided to the adjacent network element. The process repeats at Step 420 for the next network element in the communication link.

FIG. 20 illustrates a logic diagram for processing a delete link command when the network elements are coupled in a UPSR ring. The process begins at Step 440 where the network element determines the type of support it is providing to the communication link. The type of support may be the add node of a ring, the drop node of a ring, or a continuing node of a ring. When the network element is providing the add node support, the process proceeds to Steps 442 and 448. At Step 442, the network element deletes resources with respect to an adjacent network element in the backup path. The process then proceeds to Step 444 where the network element generates a local delete link. The process then proceeds to Step 446 where the network element provides the local delete link command to the adjacent network element in the backup path. The process then returns to Step 420 of FIG. 19.

At Step 448, the network element deletes resources with respect to the adjacent network element in the working path. The process then proceeds to Step 450 where the network element generates a network element link command to delete the communication link. The process then proceeds to Step 452 where the network element provides the network element link command to the adjacent network element in the working path. At this point, the process returns to Step 420 of FIG. 19.

If the support provided by the network element is a continuing node, the process proceeds to Step 454. At Step 454, the network element deletes resources with respect to the adjacent network element in the ring. The process then proceeds to Step 456 where the network element generates a network element link command to delete the communication link. The process then proceeds to Step 458 where the network element provides the network element link command to the adjacent network element in the ring. At this point, the processing returns to Step 420 of FIG. 19.

If the support provided by the network element was as a drop node, the process proceeds to Step 460. At Step 460, the network element deletes the selection of the working path or the backup path as the active path. The process then proceeds to Step 462 where the network element deletes resources with respect to the adjacent network element not in the ring. The process then proceeds to Step 464 where the network element generates a network element link command to delete the communication link. The process then proceeds to Step 466 where the network element provides the network element command to delete the link to the adjacent network element not in the ring. At this point, the process returns to Step 420 of FIG. 19.

FIG. 21 illustrates a logic diagram of a method for processing a network manager command to delete a communication link when the type of coupling is within a BLSR ring. The process begins at Step 470 where the network element determines the type of support it is providing for the communication link. The type of support that the network element may provide is as an addition node, a continuing node, or a drop node. When the type of support being provided is as an add node, the process proceeds to Step 472. At Step 472, the network element deletes resources of each network element of the backup path. The process then proceeds to Step 474 where the network element deletes resources with respect to the adjacent network element in the working path. The process then proceeds to Step 476 where the network element generates a network element link command to delete the communication link. The process then proceeds to Step 478 where the network element provides the network element link command to the adjacent network element in the working path. At this point, the processing returns to Step 420 of FIG. 19.

If the type of support provided by the network element is as a continuing node, the process proceeds to Step 480. At Step 480, the network element deletes resources with respect to the adjacent one of the plurality of network elements. The process then proceeds to Step 482 where the network element generates a network element link command to delete the communication link. The process then proceeds to Step 484 where the network element provides the network element link command to the adjacent one of the plurality of network elements. At this point, the process returns to Step 420 of FIG. 19.

If the type of support provided by the network element is as a drop node, the process proceeds to Step 486. At Step 486, the network element deletes resources with respect to the adjacent network element not in the protected ring. The process then proceeds to Step 488 where the network element generates a network element link command to delete the communication link. The process then proceeds to Step 490 where the network element provides the network element link command to the adjacent network element not in the protected ring. At this point, the processing returns to Step 420 of FIG. 19.

As one of average skill in the art will appreciate from the processing steps illustrated in FIGS. 19 through 21, a network manager may issue a single delete link command that is processed by the plurality of network elements supporting the communication link. In a similar fashion the establishment of a communication link, the network elements delete a communication link. In particular, one network element receives the request to delete a communication link from a network manager and then propagates the request to adjacent network elements in the communication link until the termination node is reached. At that point, the termination node deletes the resources and provides an acknowledgment back to the previous adjacent network element, which is propagated back to the network manager.

FIG. 22 illustrates a logic block diagram for processing a network manager command that indicates the modification of an existing communication link. In essence, the modification of a link is the combination of the deletion of a link or a portion thereof and establishing a new communication link or portion thereof. Such processing will be in accordance with the previously defined steps for deleting a link of FIGS. 19 through 21 and of establishing a communication link as illustrated in FIGS. 11 through 17.

The processing begins at Steps 500 and 510. At Step 500, a network element determines whether it is a termination node for the existing communication link. If so, the process proceeds to Step 502 where the network element deletes the allocation of resources to the communication link. This was described with reference to FIGS. 19 through 21. The process then proceeds to Step 504 where an acknowledgment of deletion of the communication link is generated and provided back to the network manager.

If the network element is not a termination node, the process proceeds to Step 506 where the network element determines the type of coupling to the plurality of network elements of the communication link. The process then proceeds to Step 508 where the network element deletes resources of the plurality of network elements based on the type of coupling. This was illustrated in FIGS. 19 through 21. Having deleted the resources, the process repeats at Step 500.

At Step 510, the network element determines whether the modify link command for establishing the new link or portion thereof, includes protection criteria. If so, the processing proceeds to the logic diagram of FIG. 23. If not, the process proceeds to Step 512 where the network element determines an optimal path for the modified communication link. The modified communication link will include a plurality of network elements. The process then proceeds to Step 514 where the plurality of network elements processes the modified link command based on the type of path. Such processing of a link command has been described with reference to FIGS. 11 through 17.

FIG. 23 illustrates a logic diagram of a method for processing a network manager command that includes protection criteria. The process begins at Step 520 where a determination is made by the network element as to whether it is a termination node. If so, the process proceeds to Step 522 where the network element allocates its resources to support the link between the 1^{st} and 2^{nd} ports and generates an acknowledgment that the link has been established. The acknowledgment is propagated through the plurality of network elements comprising the communication link until it reaches the network manager.

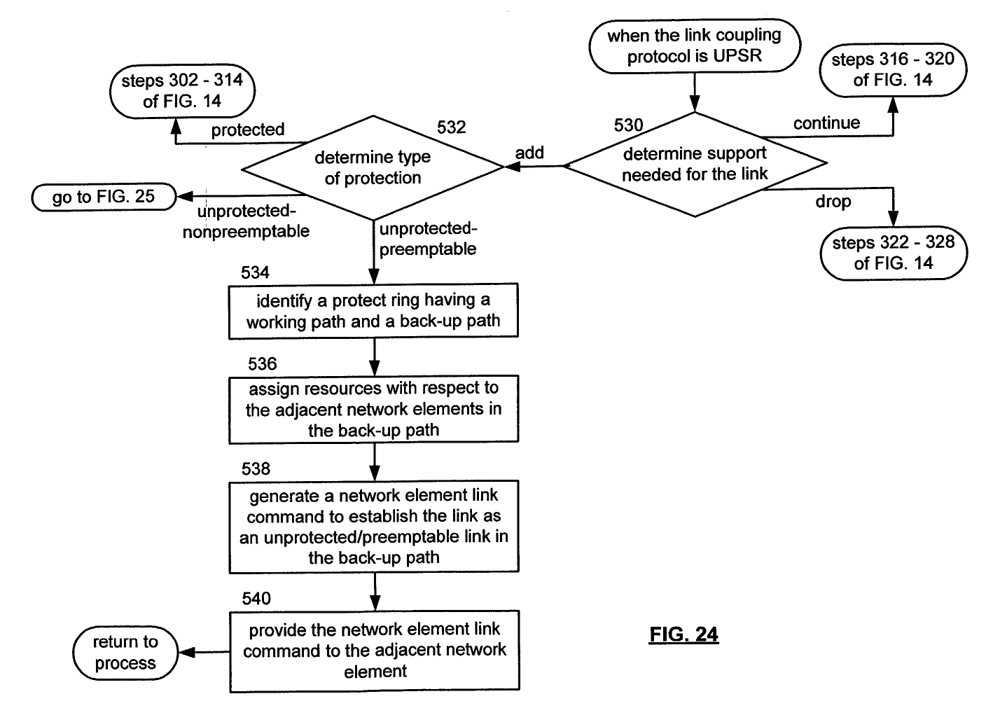

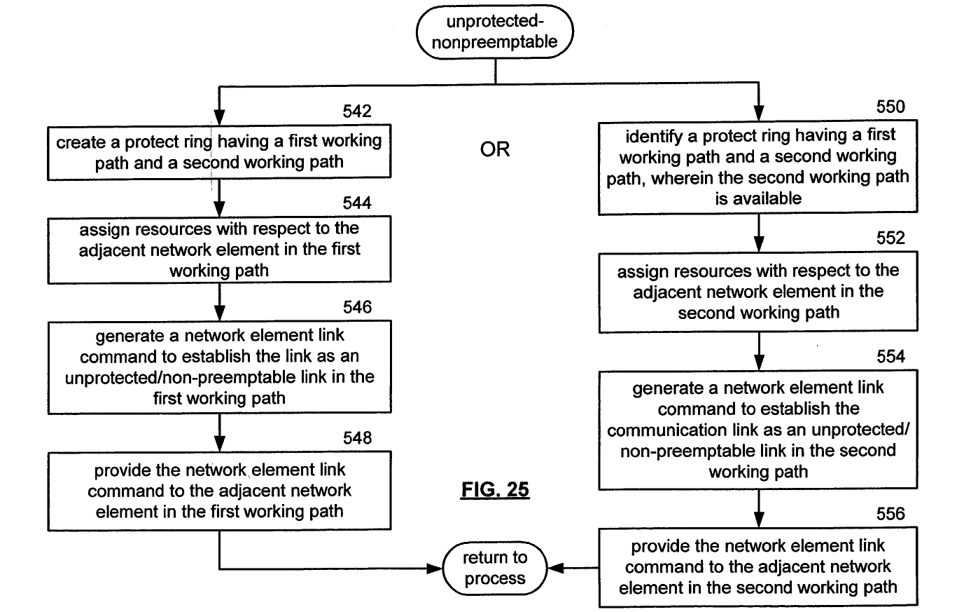

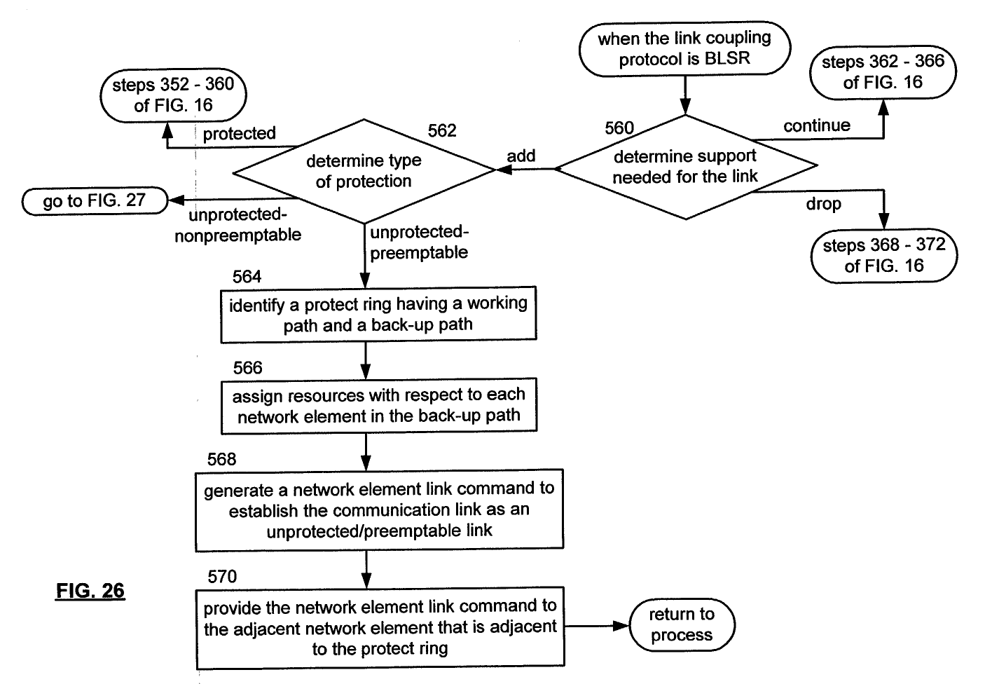

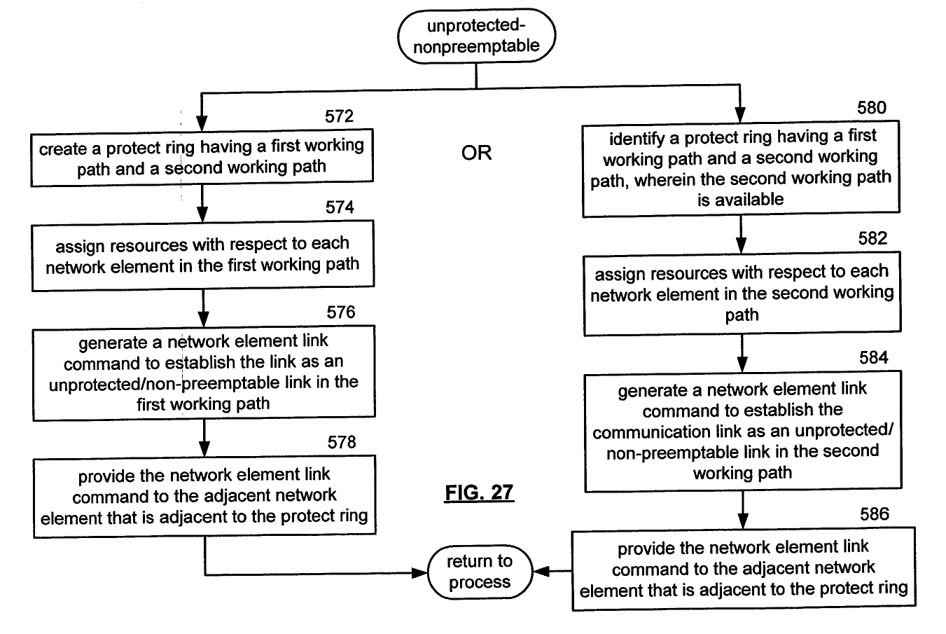

If the network element is not a termination node, the process proceeds to Step 524 where the network element determines an optimal path for the link based on the link protection criteria. The link will include a plurality of network elements. The process then proceeds to Step 526 where the network element determines the type of path to an adjacent one of the plurality of network elements based on a link coupling protocol that is utilized to couple the current network element to the adjacent network element. The process then proceeds to Step 528 where the network element processes the link command based on the type of path to the adjacent network element. At this point, the process repeats at Step 520. The detailed processing of Steps 526 and 528 are further described in FIGS. 24 and 25 when the link coupling protocol is a SONET ring that utilizes UPSR, FIGS. 26 and 27 when the link coupling protocol is a SONET ring that utilizes BLSR, and FIG. 28 when the link coupling protocol is linear.

FIG. 24 illustrates the processing of Steps 526 and 528 of FIG. 23 when the link coupling protocol is UPSR. The processing begins at Step 530 where the network element determines the type of support needed for the requested communication link. If the type of support needed is to function as a continuing node in a UPSR ring, the processing is as described with reference to Steps 316 through 320 of FIG. 14. If the type of support needed is to function as a drop node in a ring, the processing is as described in Steps 322 through 328 of FIG. 14.

If the type of support needed is to function as an add node, the process proceeds to Step 532. At Step 532, the network element determines the type of protection. If the type of protection is to be fully protected, the processing is as described with reference to Steps 302 through 314 of FIG. 14. If the type of protection is unprotected and non-preemptable, the processing proceeds to the logic diagram of FIG. 25. If the type of protection is to be unprotected and preemptable, the process proceeds to Step 534.

At Step 534, the network element identifies a protection ring having a working path and a backup path. As such, the network element is identifying an existing protected ring that is used for an existing communication link and the backup ring is currently unused. The process then proceeds to Step 536 where the network element assigns resources with respect to the adjacent network element in the backup path. The process then proceeds to Step 538 where the network element generates a network element link command to establish the link as an unprotected preemptable link in the backup path. The process then proceeds to Step 540 where the network element provides the network element link command to an adjacent network element in the backup path. At this point, the process returns to Step 520 of 5. FIG. 23.

As previously discussed with reference to FIGS. 12 and 13, an unprotected preemptable link in a SONET ring utilizes the backup path of a fully protected ring to support the link. When the fully protected ring needs its backup path because its working path failed, the non-protected and preemptable link is interrupted such that the backup path can become the active path for the fully protected communication link. This is true for a UPSR SONET ring or a BLSR SONET ring.

FIG. 25 illustrates the processing steps of allocating resources for an unprotected and non-preemptable ring. The processing begins at Step 542 or Step 550. At Step 542, the network element creates a protective ring having a 1^{st} working path and a 2^{nd} working path. The process then proceeds to Step 544 where the network element assigns resources with respect to the adjacent network element in the 1^{st} working path. The process then proceeds to Step 546 where the network element generates a network element link command to establish the link as an unprotected non-preemptable link in the 1^{st} working path. The process then proceeds to Step 548 where the network element provides the network element link command to the adjacent network element in the ₁^{st} working path. At this point, the processing returns to Step 520 of FIG. 23.

At Step 550, the network element identifies a protection ring having a 1^{st} working path and a 2^{nd} working path, where the 2^{nd} working path is available. The process then proceeds to Step 552 where the network element assigns resources with respect to the adjacent network element in the 2^{nd} working path. The process then proceeds to Step 554 where the network element generates a network element link command to establish the communication link as an unprotected non-preemptable link in the 2^{nd} working path. The process then proceeds to Step 556 where the network element provides the network element link command to the adjacent network element in the 2^{nd} working path. At this point, the processing returns to Step 520 of FIG. 23.

As previously discussed, an unprotected and non-preemptable ring utilizes the working path and backup path both as active working paths for different communication links. As such, neither path has protection. Thus, if one of the working paths fails, the communication via that path is interrupted until the failure is cured. Accordingly, the other path in the ring is not preempted to backup the other path if a failure occurs. This is true for a UPSR SONET ring or a BLSR SONET ring.

FIG. 26 illustrates a logic diagram for processing a network manager command that includes protection criteria when the link coupling between network elements is in a SONET BLSR ring. The processing begins at Step 560 where the network element determines the support needed for the communication ring. If the support needed is for the network element to function as a continuing node, the processing of Steps 362 through 366 of FIG. 16 are followed. If the support needed is for the network element to function as a drop node, the processing follows Steps 368 through 372 of FIG. 16. If the support needed is for the network element to function as an add node, the process proceeds to Step 562. At Step 562, the network element determines the type of protection. If the type of protection is fully protected, the processing follows Steps 352 through 360 of FIG. 16. If the type of protection is unprotected and non-preemptable, the processing follows the steps of the logic diagram shown in FIG. 27. If the type of protection is unprotected and preemptable, the process proceeds to Step 564.

At Step 564, the network element identifies a protection ring having a working path and a backup path. The protected ring utilizes the working path as the current means for transporting data and has the backup path as a reserve. The process then proceeds to Step 566 where the network element assigns resources with respect to each network element in the backup path. The process then proceeds to Step 568 where the network element generates a network element link command to establish the communication link as an unprotected and preemptable link. The process then proceeds to Step 570 where the network element provides the network element link command to the adjacent network element that is adjacent to the protected ring. At this point, the processing returns to Step 520 of FIG. 23.

FIG. 27 illustrates a logic diagram of a method for processing the network manager command in a BLSR ring when the type of protection is unprotected and non-preemptable. The processing begins at Step 572 or Step 580. At Step 572, the network element creates a protected ring having a 1^{st} working path and a 2^{nd} working path. The process then proceeds to Step 574 where the network element assigns resources with respect to each network element in the 1^{st} working path. The process then proceeds to Step 576 where the network element generates a network element link command to establish the link as an unprotected and non-preemptable link in the 1^{st} working path. The process then proceeds to Step 578 where the network element provides the network element link command to the adjacent network element that is adjacent to the protected ring. At this point, the processing returns to Step 520 of FIG. 23.

At Step 580, the network element identifies a protection ring having a 1^{st} working path and a 2^{nd} working path where the 2^{nd} working path is available. The processing then proceeds to Step 582 where the network element assigns resources with respect to each network element in the 2^{nd} working path. The process then proceeds to Step 584 where the network element generates a network element link command to establish the communication link as an unprotected and non-preemptable link in the 2^{nd} working path. The process then proceeds to Step 586 where the network element provides the network element link command to the adjacent network element that is adjacent to the protected ring. At this point, the processing returns to Step 520 of FIG. 23.

FIG. 28 illustrates a logic diagram of a method for processing a network manager command that includes protection criteria and the type of coupling is linear. The process begins at Step 590 where the network element determines the type of protection. When the type of protection is unprotected, the processing follows that of Step 282 of FIG. 11. If the type of protect is one-to-one protection, the processing proceeds to Step 592. At Step 592, the network element assigns 1^{st} resources with respect to the adjacent network element. The process then proceeds to Step 594 where the network element assigns 2^{nd} resources with respect to the adjacent network element. The process then proceeds to Step 596 where the network element generates a network element link command to establish the communication link as a protected link. The process then proceeds to Step 598 where the network element provides the network element link command to the adjacent network element. At this point, the processing returns to Step 520 of FIG. 23. Note that when the type of protection is one-to-one linear, two linear links are established between each network element to provide a working path and a backup path.

FIG. 29 illustrates a logic diagram of an alternate method for processing a command that includes protection criteria. The process begins at Step 600 where the network element receives a link command that includes link protection criteria. The process then proceeds to Step 602 where the network element determines whether the link command is a network manager link command or a network element link command. When the link command is a network manager link command, the process proceeds to Step 604.

At Step 604, the network element determines an optimal path for the link via a plurality of network elements in accordance with the type of link protection. For example, if the link protection is fully protected and the network element can go through a linear path or a plurality of SONET rings, the network element will choose the plurality of SONET rings since it provides the desired protection level even though more network elements are needed to support the communication link. The process then proceeds to Step 606 where the network element determines the type of path to the adjacent network element based on the link coupling protocol that is employed to couple the network elements together. The process then proceeds to Step 608 where the network element processes the link command based on the type of path to the adjacent network. The process then repeats at Step 600. For a detailed discussion of the processing performed by Steps 606 and 608, refer to FIGS. 24 through 28.

If the link command is a network element command, the process proceeds at Step 610. At Step 610, the network element determines whether it is a termination node. If so, the process proceeds to Step 612 where the network element allocates resources to support the communication link between the 1^{st} and 2^{nd} ports. In addition, the network element generates an acknowledgment signal that the link has been established and relays the acknowledgment signal to a previous adjacent network element. The network elements propagate the acknowledgment signal back to the network manager such that it is aware that the communication link has been established.

As one of average skill in the art will appreciate, by including a control layer within each of the network elements, a wide variety of functionality in typical routing and networking functions may be performed by the network elements. As such, manual operations of network managers can be reduced for such tasks as creating a link, modifying a link and deleting a link. In addition, links of various types of protection levels may be automatically created, modified, and/or deleted.

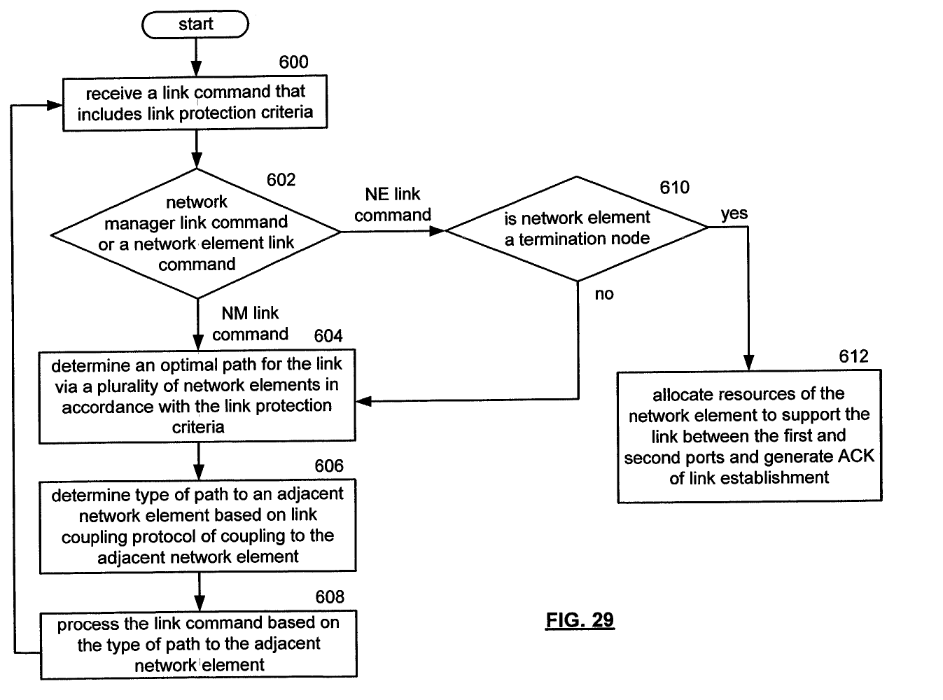

FIG. 30 illustrates a schematic block diagram of a SONET communication network that includes a plurality of network elements 140 through 163. The network elements support a communication link between Port A and Port B. In addition, each of the network elements is associated with a particular grouping of network elements. For example, network element 140 is in grouping 632. Network elements 141 through 146 are in grouping 624. Network elements 147 through 155 are in grouping 626. Network elements 156 through 158 are in grouping 630 and network elements 159 through 163 are in grouping 628.

The network elements 140-163 may be grouped based on the manufacturer of the network element such that network elements manufactured by the same vendor are grouped together. Alternatively, the network elements may be grouped based on the particular type of functions they perform or they may be grouped based on their geographic locations.

A network manager administers each grouping of network elements. For example, network manager 120 administers to grouping 632, grouping 628, and grouping 626. Network manager 620 administers to grouping 624 and network manager 622 administers to grouping 630. At the network manager level, network manager 120, network manager 620, and network manager 622 are independent entities. As such, there is no communication between such devices, they are usually located in physically different locations, and are operated by different network administrators.

To establish the communication link between Port A and Port B requires cooperation between the network administrators of network manager 120, 620 and 622. The network manager 120 allocates resources to support the communication link between Port A and Port B within groupings 632, 626 and 628. Network manager 620 allocates resources to support the communication link between Port A and Port B via grouping 624. Network manager 622 provides the support for the network elements in grouping 630.

In prior art communication systems, network manager 120 would treat each grouping 626, 628 and 632 as separate group. As such, when the link between Port A and Port B needed to be established, the network manager would go to each grouping to facilitate the establishment of the communication link. When the link was to be modified or deleted, the network manager would again access each group individually to perform such a function. The present invention enables the network manager 120 to treat groupings 626, 628 and 632 as a single grouping for the communication link between Port A and Port B.

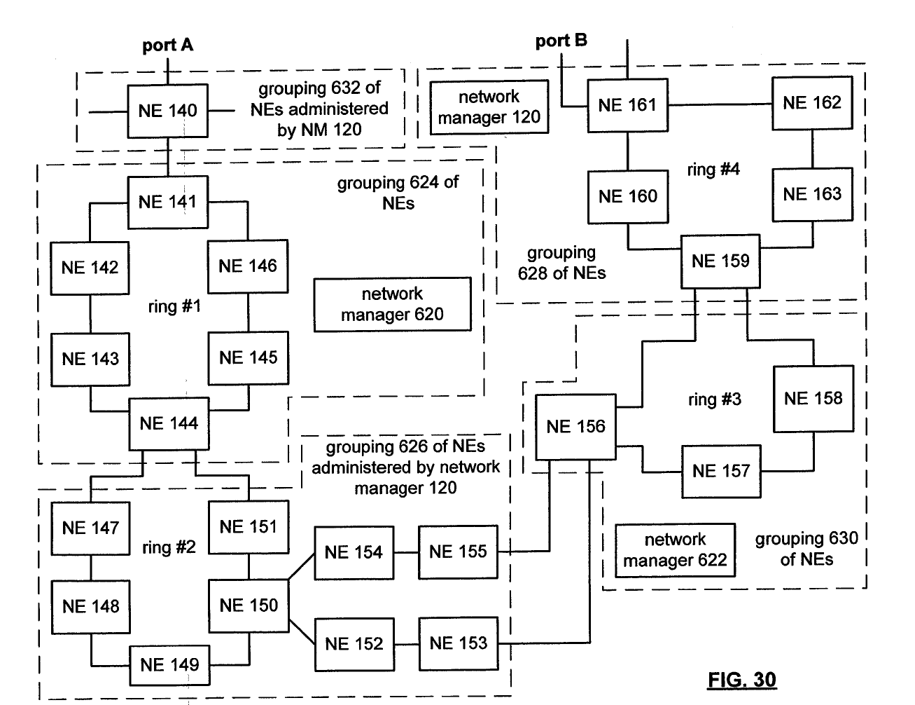

FIG. 31 illustrates a schematic block diagram of the communication link between Port A and Port B. As shown, the communication link between Port A and Port B is supported by network element 140, SONET ring #1, SONET ring #2, network elements 152 through 155, SONET ring #3 and SONET ring #4. Network element 140, SONET ring #2, network elements 152 through 155, and SONET ring #4 are all supported by network manager 120. Thus, by assigning these separate groupings of network elements a single path identifier, the network manager 120 may utilize that path identifier to issue commands to all network elements in each of the groupings. As such, the network manager no longer has to access each individual grouping or each individual network element to facilitate a command regarding the communication link between Port A and Port B.

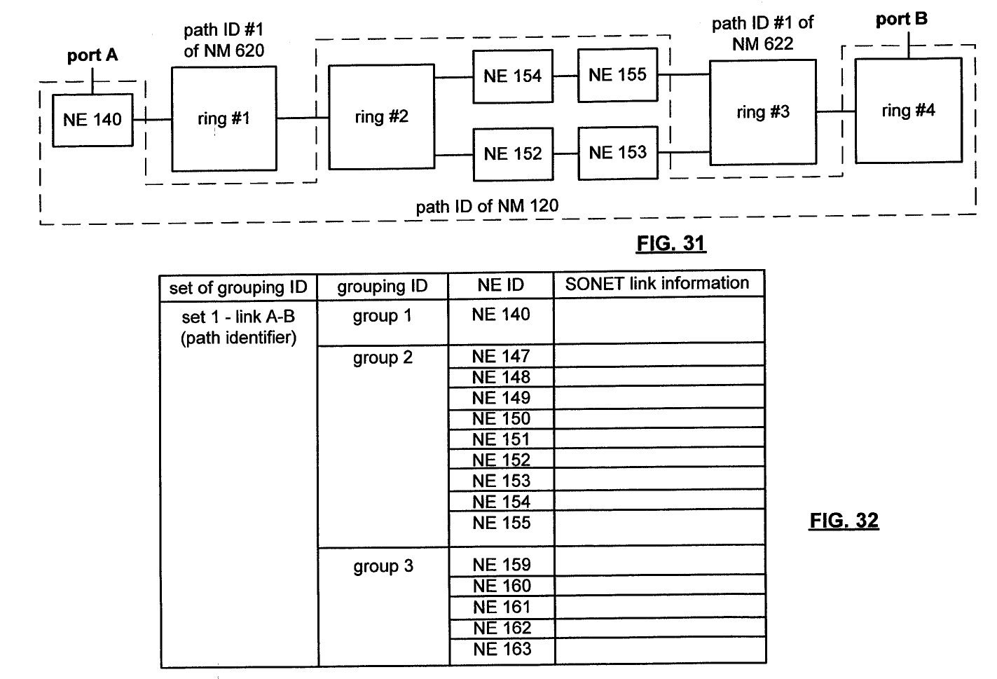

FIG. 32 illustrates a graphical representation of a table that may be included in a network manager and/or in each of the plurality of network elements of the communication network 12. The table includes a path identifier field for including a name for a set of groupings of network elements, a field for a grouping ID, a field for network element ID and a SONET link information field. The SONET link information field will include the known pieces of information that each network element needs to support a communication link. Since the SONET link information is known, no further discussion will be provided except to facilitate the understanding of the present invention.

The network element ID field includes the identity of each network element in the communication link. The grouping ID field includes the group name for each group of network elements in the communication link. The path identifier field identifies includes the path identifier, which is the name for a set of groupings of network elements that are all of the same type. Each network manager may include its own table for the set of groupings of network elements that make up the communication link.

The illustration of FIG. 32 is for network manager 120 regarding the communication link between Port A and Port B of FIG. 31. Accordingly, group 1 of network elements includes network element 140. Group 2 includes network elements 147 through 155 and group 3 includes network elements 159 through 161. A path identifier is given to the set of groupings. Thus network elements 140, 147-155, and 159-161 may be accessed via a single command regarding the communication link between Port A and Port B.

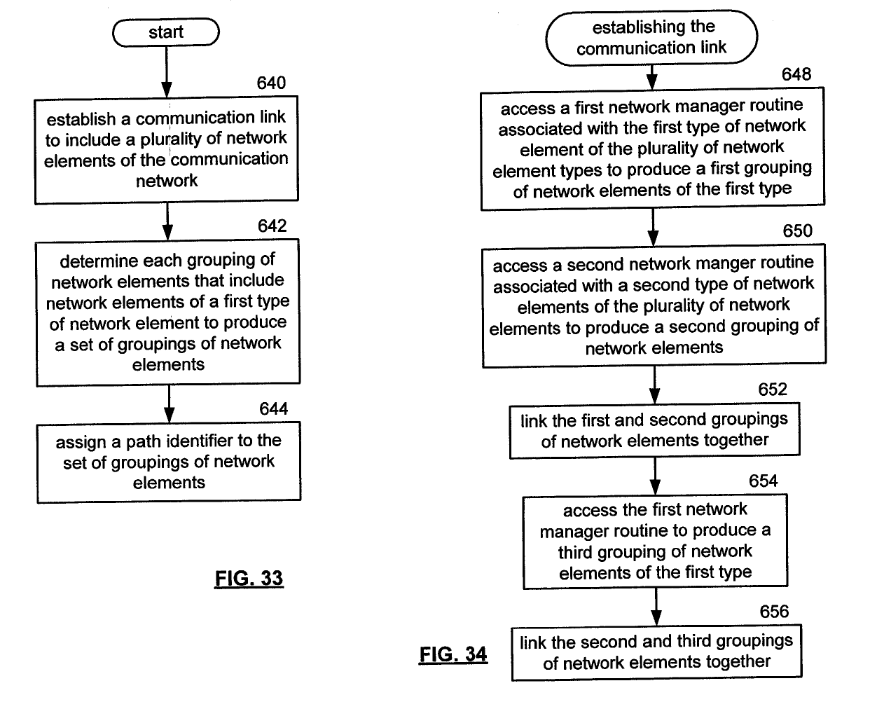

FIG. 33 illustrates a logic diagram of a method for establishing a path identifier in a communication network. The process begins at Step 640 where a communication link is established via a plurality of network elements within the communication network. Each of the network elements is of a particular type of network element (e.g., of like function, manufactured by the same vendor, and/or in the same geographic location). In addition, each network element of like types is arranged into groupings of network elements.

The process then proceeds to Step 642 where each grouping of network elements that includes network elements of the 1^{st} type of network element is determined to produce a set of groupings of network elements. This may be done by obtaining a vendor identification of the network elements, by obtaining the functional capabilities of the network element to establish the 1^{st} type, or by obtaining a 1^{st} type identifier of the network element. For example, each network element may include an identifier that associates it with a particular grouping. The grouping of network elements in accordance with the type of network element was illustrated in FIG. 31.

The process then proceeds to Step 644 where a path identifier is assigned to the set of groupings of network elements. This was illustrated in FIGS. 31 and 32. By assigning a unique identifier to a set of groupings of network elements, a network manager may utilize the path identifier to address all of the network elements that support a particular communication link without having to individually address the network elements or individually address the groupings of network elements.

FIG. 34 illustrates a logic diagram of a method for establishing the communication link as described as illustrated in Step 640 of FIG. 33. The processing begins at Step 648 where a 1^{st} network manager routine is accessed to produce a 1^{st} grouping of network elements of the 1^{st} type. For example, in the illustration of FIG. 30, network manager 120 accesses a routine to address network element 140 and request it to reserve resources for the communication link. The routine may be in accordance with the automatic processing described herein or in accordance with existing network manager routines to establish a communication link. When network element 140 receives the command, it allocates resources to support the communication link.

The process then proceeds to Step 650 where a 2^{nd} network manager routine is accessed to process allocation of resources in a 2^{nd} grouping of network elements. In the example of FIG. 30, network element 620 utilizes a network manager routine to cause network elements 141 through 146 to allocate resources to support the communication link between Port A and Port B.

The process then proceeds to Step 652 where the 1^{st} grouping of network elements and 2^{nd} grouping of network elements are linked together. Referring to the diagram of FIG. 30, resources have been allocated via Step 648 to support communication link between Ports A and B in network element 140 and have been allocated with reference to Step 650 in the SONET ring #1. Step 652 is now assigning resources to link network element 140 to network element 142.

The process then proceeds to Step 654 where the 1^{st} network manager routine is again accessed to allocate resources in a 3^{rd} grouping of network elements wherein the 3^{rd} grouping includes network elements of the 1^{st} type. For example, referring to FIG. 30, grouping 626, which is administered by network manager 120, causes resources in network elements 147 through 155 to be allocated to support the communication link between Port A and Port B.

Returning to the flow of FIG. 34, the process proceeds to Step 656. At Step 656, the 2^{nd} and 3^{rd} groupings of network elements are linked together. Referring back to the example of FIG. 30, the resources within ring 2 and resources within ring 1 are linked together to facilitate the coupling of ring 1 to ring 2. The processing would continue by allocating resources within the grouping 630 of network elements by network manager 622. Once the resources have been allocated in ring 3, resources would be allocated to link ring 3 to network elements 155 and 153. Similarly, resources would be allocated within ring 4, which comprise grouping 628, to support the communication link. Once the resources have been allocated within grouping 628, resources would be allocated to link ring 4 to ring 3. Once this is done, the communication link between Port A and Port B is established.

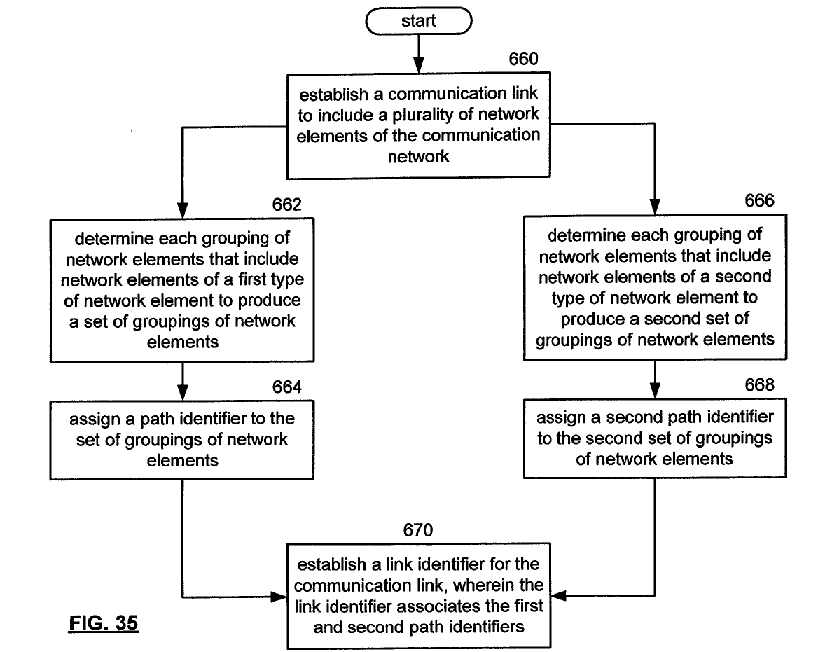

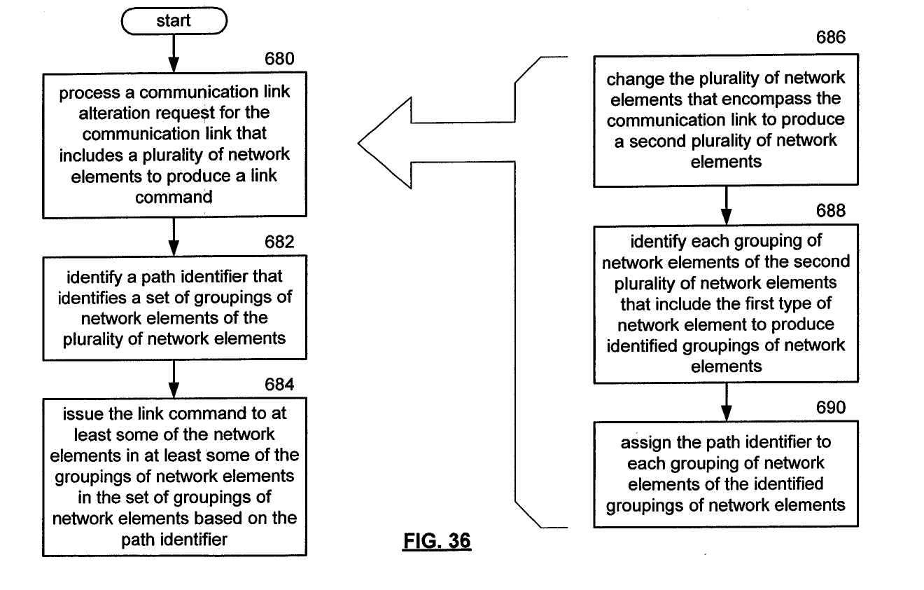

FIG. 35 illustrates a logic diagram of an alternate method for establishing a path identifier in a communication network. The process begins at Step 660 where a communication link is established via a plurality of network elements that are within a communication network. The process then proceeds to Step 662 and 666. At Step 662, each grouping of network elements that includes network elements of a 1^{st} type of network element is determined to produce a set of groupings of network elements. This is similar to Step 640 of FIG. 33. The process then proceeds to 664 where a path identifier is assigned to the set of groupings. This is similar to Step 644 of FIG. 33.

At Step 666, each grouping of network elements that includes network elements of a 2^{nd} type of network element is determined to produce a 2^{nd} set of groupings of network elements. This is similar to Step 642 of FIG. 33 but for a different grouping of network elements. The process then proceeds to Step 668 where a 2^{nd} path identifier is assigned to the second set of groupings of network elements. The process then proceeds to Step 670 where a link identifier is established for the communication link that associates the 1^{st} and 2^{nd} path identifiers. As such, a single link identifier may address the entire communication link.

For example, referring to FIGS. 31 and 32, the communication link between Port A and Port B includes three different sets of network elements. The 1^{st} set is managed by network manager 120 and includes network element 140, rings 2 and 4 and network elements 152 through 155. As such, this set of groupings of network elements would have a path identifier. Ring 1, which is supported by network manager 620, would have its own unique path identifier as would ring 3, which is supported by network manager 620. As such, the communication link between Port A and Port B has 3 path identifiers each being supported by a different network manager. By assigning a link identifier that links the individual path identifiers of the individual network managers together, the entire communication link between Port A and Port B would have a single identifier. This however, requires cooperation between network manager 620, 120 and 622. With such cooperation, the table of FIG. 3 would further include a column for the link identifier that ties the path identifiers together. In addition, the path identifier field (e.g., the set of grouping ID field), the grouping identification field, the network element identification field and the SONET link information field would include the network elements of ring 1 and ring 3 and their corresponding network managers 620 and 622.

FIG. 36 illustrates a logic diagram of a method for altering a communication link in a communication system utilizing a path identifier. The processing steps may be implemented by a network manager or by a plurality of network elements receiving a request from a network manager. Such processing begins at Step 680 where a communication link alteration request for a particular communication link is processed. The communication link is supported by a plurality of network elements. The processing of the communication link is further illustrated in Steps 686 through 690.

At Step 686, the plurality of network elements that encompass the communication link are changed to produce a 2^{nd} plurality of network elements. The process then proceeds to Step 688 where the identity of each grouping of the network elements of the 2^{nd} plurality of network elements that include the 1^{st} type of network elements is identified to produce identified groupings of network elements. The process then proceeds to Step 690 where a path identifier is assigned to each group of the network elements of the identified groupings of network elements. As such, if the existing communication link is to be modified, the new link is established as described in accordance with previously described operations. Once the new link is established, the network elements of a like type are grouped and a path identifier associates the groups that include the like type of network elements.

The process then proceeds to Step 682 where a path identifier that identifies a set of groupings of network elements is identified. The process then proceeds to Step 684 where a link command is issued to at least some of the network elements and at least some of the groupings of network elements to process the link command. The processing of the link command causes the network elements to modify and/or delete the link accordingly.

The preceding discussion has presented a method and apparatus for enhancing communications within a communication system. By adding a control layer to network elements, such as a SONET network element, automatic processing of communication links is greatly enhanced. As one of average skill in the art will appreciate, other embodiments may be derived from the teachings of the present invention without deviating from the scope of the claims.

What is claimed is:

1. A method for a network element to support a communication link in a communication network, the method comprises the steps of:
receiving a link command;
determining type of the link command;
when the type of the link command is an establish a connection command, determining whether the network element is a termination node of the communication link;
when the network element is not a termination node of the communication link, determining an optimal path for the communication link via a plurality of network elements of the communication network;
determining type of path to an adjacent one of the plurality of network elements; and
processing the link command based on the type of path to the adjacent one of the plurality of network elements.

2. The method of claim 1, wherein the link command includes identity of a first port and second port of the communication link, wherein the determining the optimal path further comprises:
executing a program to identify the optimal path to the second port of the communication link (Dykstra routine).

3. The method of claim 1 further comprises:
when the network element is the termination node, allocating resources of the network element for the communication link;
generating an acknowledgement of establishment of the communication link; and
providing the acknowledgement to another network element of the plurality of network elements.

4. The method of claim 1, wherein the determining the type of path further comprises:
determining a link coupling protocol for coupling to the adjacent one of the plurality of network elements.

5. The method of claim 4, wherein the processing the link command further comprises:
when the link coupling protocol is unidirectional path-switched ring (UPSR), determining support needed for the communication link;
when the support needed is to add a connection:
creating a protect ring having a working path and a back-up path;
assigning resources with respect to the adjacent one of the plurality of network elements in the working path;
generating a network element link command to establish the communication link; and
providing the network element link command to the adjacent one of the plurality of network elements.

6. The method of claim 5 further comprises:
assigning resources with respect to an adjacent network element in the back-up path;
generating a local make link command; and
providing the local make link command to the adjacent network element.

7. The method of claim 5 further comprises:
when the support needed is to continue the connection:
assigning resources with respect to the adjacent one of the plurality of network elements;
generating a network element link command to establish the communication link; and
providing the network element link command to the adjacent one of the plurality of network elements.

8. The method of claim 5 further comprises:
when the support needed is to drop the connection:
implementing a selection of the working path or the back-up path as an initial active path;
assigning resources with respect to the adjacent one of the plurality of network elements in the working path;
generating a network element link command to establish the communication link; and
providing the network element link command to the adjacent one of the plurality of network elements.

9. The method of claim 4, wherein the processing the link command further comprises:
when the link coupling protocol is linear:
assigning resources with respect to the adjacent one of the plurality of network elements;
generating a network element link command to establish the communication link; and
providing the network element link command to the adjacent one of the plurality of network elements.

10. The method of claim 4, wherein the processing the link command further comprises:
when the link coupling protocol is bi-directional line switched ring (BLSR), determining support needed for the communication link;
when the supported needed is to add a connection:
creating-a protect ring having a working path and a back-up path;
assigning resources in each network element of the back-up path;
assigning resources with respect to the adjacent one of the plurality of network elements in the working path;
generating a network element link command to establish the communication link; and
providing the network element link command to the adjacent one of the plurality of network elements.

11. The method of claim 10 further comprises:
when the support needed is to continue the connection:
assigning resources with respect to the adjacent one of the plurality of network elements;
generating a network element link command to establish the communication link; and
providing the network element link command to the adjacent one of the plurality of network elements.

12. The method of claim 10 further comprises:
when the support needed is to drop the connection:
assigning resources with respect to the adjacent one of the plurality of network elements not in the protected ring;
generating a network element link command to establish the communication link; and
providing the network element link command to the adjacent one of the plurality of network elements.

13. The method of claim 1 further comprises:
when the type of the link command is a local make link command, allocating resources for the communication link.

14. The method of claim 1 further comprises:
when the type of link command is a delete link command, determining whether the network element is a termination node of the communication link;
when the network element is not the termination node of the communication link, determining type of coupling to the adjacent one of the plurality of network elements;
when the type of coupling is linear:
deleting allocation of resources of the network element to the communication link;
generating a network element delete link command; and
providing the network element delete link command to the adjacent one of the plurality of network elements.

15. The method of claim 14 further comprises:
when the network element is the termination node of the communication link:
deleting allocation of resources of the network element to the communication link; and
generating an acknowledgement of deletion of the communication link.

16. The method of claim 14 further comprises:
when the type of coupling is a BLSR node:
determining support provided to the communication link;
when the support is an add node:
deleting allocation of resources with respect to the adjacent one of the plurality of network elements;
deleting resources in each network element of a backup path;
generating a network element delete link command;
providing the network element delete link command to the adjacent one of the plurality of network elements;
when the support is a continue node:
deleting allocation of resources with respect to the adjacent one of the plurality of network elements;
generating a network element delete link command;
providing the network element delete link command to the adjacent one of the plurality of network elements;
when the support is a drop node:
deleting allocation of resources with respect to the adjacent one of the plurality of network elements not in the protected ring;
generating a network element delete link command;
providing the network element delete link command to the adjacent one of the plurality of network elements not in the protected ring.

17. The method of claim 14 further comprises:
when the type of coupling is a UPSR node:
determining type of support provided to the communication link;
when the type of support is add node:
deleting resources with respect to the adjacent one of the plurality of network elements in a working path;
generating a network element delete link command;
providing the network element delete link command to the adjacent one of the plurality of network elements and to the network element in the working path;
deleting resources with respect to an adjacent network element in a back-up path;
generating a local delete link command; and
providing the local delete link command to the adjacent network element in the back-up path;
when the type of support is continue node:
deleting resources with respect to the adjacent one of the plurality of network elements;
generating the network element delete link command;
providing the network element delete link command to the adjacent one of the plurality of network elements and to the network element;
when the type of support is drop node:
deleting selection of the back-up path or the working path as an active path;
deleting resources with respect to the working path and the back-up path;
deleting resources with respect to the adjacent one of the plurality of network elements not in the working path;
generating the network element delete link command; and
providing the network element delete link command to the adjacent one of the plurality of network elements and to the network element.

18. The method of claim 1 further comprises:
when the type of link command is a modify link command, determining whether the network element is a termination node of the communication link;
when the network element is not the termination node of the communication link:
determining type of coupling to the adjacent one of the plurality of network elements; and
deleting resources of the plurality of network elements based on the type of coupling;
determining a second optimal path for a modified communication link via a second plurality of network elements of the communication network; and
processing, by the second plurality of network elements, the modify link command based on the type of path to the second adjacent network element to establish the modified communication link.

19. A method for supporting a communication link in a communication network, the method comprises the steps of:
receiving a link command;
determining whether the link command is a network manager link command or a network element link command, wherein the link command identifies at least one of a first port and a second port of the communication link;
when the link command is a network manager link command:
determining type of the link command;
when the type of the link command is an establish a connection command:
determining an optimal path for the communication link via a plurality of network elements of the communication network;
determining type of path to an adjacent one of the plurality of network elements based on link coupling protocol of coupling to the adjacent one of the plurality of network elements; and
processing the link command based on the type of path to the adjacent one of the plurality of network elements.

20. The method of claim 19, wherein the processing the link command further comprises:
when the link coupling protocol is UPSR, determining support needed for the communication link;
when the supported needed is to add a connection:
creating a protect ring having a working path and a back-up path;
assigning resources with respect to the adjacent one of the plurality of network elements in the working path;
generating a network element link command to establish the communication link; and
providing the network element link command to the adjacent one of the plurality of network elements.

21. The method of claim 20 further comprises:
assigning resources with respect to an adjacent network element in the back-up path;
generating a local make link command; and
providing the local make link command to the adjacent network element.

22. The method of claim 20 further comprises:
when the support needed is to continue the connection:
assigning resources with respect to the adjacent one of the plurality of network elements;
generating a network element link command to establish the communication link; and
providing the network element link command to the adjacent one of the plurality of network elements.

23. The method of claim 20 further comprises:
when the support needed is to drop the connection:
implementing a selection of the working path or the back-up path as an initial active path;
assigning resources with respect to the adjacent one of the plurality of network elements in the working path;
generating a network element link command to establish the communication link; and
providing the network element link command to the adjacent one of the plurality of network elements.

24. The method of claim 19, wherein the processing the link command further comprises:
when the link coupling protocol is linear:
assigning resources with respect to the adjacent one of the plurality of network elements in the working path;
generating a network element link command to establish the communication link; and
providing the network element link command to the adjacent one of the plurality of network elements.

25. The method of claim 19, wherein the processing the link command further comprises:
when the link coupling protocol is BLSR, determining support needed for the communication link;
when the supported needed is to add a connection:
creating a protect ring having a working path and a back-up path;
assigning resources in each network element of the back-up path;
assigning resources with respect to the adjacent one of the plurality of network elements in the working path;
generating a network element link command to establish the communication link; and
providing the network element link command to the adjacent one of the plurality of network elements.

26. The method of claim 25 further comprises:
when the support needed is to continue the connection:
assigning resources with respect to the adjacent one of the plurality of network elements;
generating a network element link command to establish the communication link; and
providing the network element link command to the adjacent one of the plurality of network elements.

27. The method of claim 25 further comprises:
when the support needed is to drop the connection:
assigning resources with respect to the adjacent one of the plurality of network elements not in the protected ring;
generating a network element link command to establish the communication link; and
providing the network element link command to the adjacent one of the plurality of network elements.

28. The method of claim 19 further comprises:
when the type of link command is a delete link command, determining type of coupling to the adjacent one of the plurality of network elements;
when the type of coupling is linear:
deleting allocation of resources of the network element to the communication link;
generating a network element delete link command; and
providing the network element delete link command to the adjacent one of the plurality of network elements.

29. The method of claim 28 further comprises:
when the type of coupling is a BLSR node:
determining support provided to the communication link;
when the support is an add node:
deleting allocation of resources with respect to the adjacent one of the plurality of network elements;
deleting resources in each network element of a backup path;
generating a network element delete link command;
providing the network element delete link command to the adjacent one of the plurality of network elements;
when the support is a continue node:
deleting allocation of resources with respect to the adjacent one of the plurality of network elements;
generating a network element delete link command;
providing the network element delete link command to the adjacent one of the plurality of network elements;
when the support is a drop node:
deleting allocation of resources with respect to the adjacent one of the plurality of network elements not in the protected ring;
generating a network element delete link command;
providing the network element delete link command to the adjacent one of the plurality of network elements not in the protected ring.

30. The method of claim 28 further comprises:
when the type of coupling is a UPSR node:
determining type of support provided to the communication link;
when the type of support is add node:
deleting resources with respect to the adjacent one of the plurality of network elements in a working path;
generating a network element delete link command;
providing the network element delete link command to the adjacent one of the plurality of network elements and to the network element in the working path;
deleting resources with respect to an adjacent network element in a back-up path;
generating a local delete link command; and
providing the local delete link command to the adjacent network element in the back-up path;
when the type of support is continue node:
deleting resources with respect to the adjacent one of the plurality of network elements;
generating the network element delete link command;
providing the network element delete link command to the adjacent one of the plurality of network elements and to the network element;
when the type of support is drop node:
deleting selection of the back-up path or the working path as an active path;
deleting resources with respect to the working path and the back-up path;
deleting resources with respect to the adjacent one of the plurality of network elements not in the working path;
generating the network element delete link command; and
providing the network element delete link command to the adjacent one of the plurality of network elements and to the network element.

31. The method of claim 19 further comprises:
when the type of link command is a modify link command, determining whether the network element is a termination node of the communication link;
when the network element is not the termination node of the communication link:
determining type of coupling to the adjacent one of the plurality of network elements; and
deleting resources of the plurality of network elements based on the type of coupling;
determining a second optimal path for a modified communication link via a second plurality of network elements of the communication network; and
processing, by the second plurality of network elements, the modify link command based on the type of path to the second adjacent network element to establish the modified communication link.

32. The method of claim 19 further comprises:
when the link command is a network element link command:
determining whether the network element is a termination node of the communication link;
when the network element is not a termination node of the communication link, determining an optimal path for the communication link via a plurality of network elements of the communication network;
determining type of path to an adjacent one of the plurality of network elements; and
processing the link command based on the type of path to the adjacent one of the plurality of network elements.

33. A network element for using in a communication system, the network element comprises:
processing module; and
memory operably coupled to the processing module, wherein the memory includes operational instructions to:
provide a SONET physical layer for conveyance of data via the network element; and
provide a control layer to substantially automate establishment of communication links within the communication system.

34. The network element of claim 33, wherein the memory further comprises operational instructions that cause the processing module to:
receive a link command;
determine type of the link command;
when the type of the link command is an establish a connection command, determine whether the network element is a termination node of the communication link;
when the network element is not a termination node of the communication link, determine an optimal path for the communication link via a plurality of network elements of the communication network;
determine type of path to an adjacent one of the plurality of network elements; and
process the link command based on the type of path to the adjacent one of the plurality of network elements.

35. The network element of claim 33, wherein the memory further comprises operational instructions that cause the processing module to:
receive a link command;
determine whether the link command is a network manager link command or a network element link command, wherein the link command identifies at least one of a first port and a second port of the communication link;
when the link command is a network manager link command:
determine type of the link command;
when the type of the link command is an establish a connection command:
determine an optimal path for the communication link via a plurality of network elements of the communication network;
determine type of path to an adjacent one of the plurality of network elements based on link coupling protocol of coupling to the adjacent one of the plurality of network elements; and
process the link command based on the type of path to the adjacent one of the plurality of network elements.

36. A network element for using in a communication system, the network element comprises:
processing module; and
memory operably coupled to the processing module, wherein the memory includes operational instructions to:
receive a link command;
determine type of the link command;
when the type of the link command is an establish a connection command, determine whether the network element is a termination node of the communication link;
when the network element is not a termination node of the communication link, determine an optimal path for the communication link via a plurality of network elements of the communication network;
determine type of path to an adjacent one of the plurality of network elements; and
process the link command based on the type of path to the adjacent one of the plurality of network elements.

37. The network element of claim 36, wherein the link command includes identity of a first port and second port of the communication link, wherein the memory further comprises operational instructions that cause the processing module to determine the optimal path by:
executing a program to identify the optimal path to the second port of the communication link.

38. The network element of claim 36, wherein the memory further comprises operational instructions that cause the processing module to:
when the network element is the termination node, allocate resources of the network element for the communication link;
generate an acknowledgement of establishment of the communication link; and
provide the acknowledgement to another network element of the plurality of network elements.

39. The network element of claim 36, wherein the memory further comprises operational instructions that cause the processing module to determine the type of path by:
determining a link coupling protocol for coupling to the adjacent one of the plurality of network elements.

40. The network element of claim 39, wherein the memory further comprises operational instructions that cause the processing module to process the link command by:
when the link coupling protocol is UPSR, determining support needed for the communication link;
when the support needed is to add a connection:
creating a protect ring having a working path and a back-up path;
assigning resources with respect to the adjacent one of the plurality of network elements in the working path;
generating a network element link command to establish the communication link; and
providing the network element link command to the adjacent one of the plurality of network elements.

41. The network element of claim 40, wherein the memory further comprises operational instructions that cause the processing module to:
assign resources with respect to an adjacent network element in the back-up path;
generate a local make link command; and
provide the local make link command to the adjacent network element.

42. The network element of claim 40, wherein the memory further comprises operational instructions that cause the processing module to:
when the support needed is to continue the connection:
assign resources with respect to the adjacent one of the plurality of network elements;
generate a network element link command to establish the communication link; and
provide the network element link command to the adjacent one of the plurality of network elements.

43. The network element of claim 40, wherein the memory further comprises operational instructions that cause the processing module to:
when the support needed is to drop the connection:
implement a selection of the working path or the back-up path as an initial active path;
assign resources with respect to the adjacent one of the plurality of network elements in the working path;
generate a network element link command to establish the communication link; and
provide the network element link command to the adjacent one of the plurality of network elements.

44. The network element of claim 39, wherein the memory further comprises operational instructions that cause the processing module to process the link command by:
when the link coupling protocol is linear:
assigning resources with respect to the adjacent one of the plurality of network elements in the working path;
generating a network element link command to establish the communication link; and
providing the network element link command to the adjacent one of the plurality of network elements.

45. The network element of claim 39, wherein the memory further comprises operational instructions that cause the processing module to process the link command by:
when the link coupling protocol is BLSR, determining support needed for the communication link;
when the supported needed is to add a connection:
creating a protect ring having a working path and a back-up path;
assigning resources in each network element of the back-up path;
assigning resources with respect to the adjacent one of the plurality of network elements in the working path;
generating a network element link command to establish the communication link; and
providing the network element link command to the adjacent one of the plurality of network elements.

46. The network element of claim 45, wherein the memory further comprises operational instructions that cause the processing module to:
when the support needed is to continue the connection:
assign resources with respect to the adjacent one of the plurality of network elements;
generate a network element link command to establish the communication link; and
provide the network element link command to the adjacent one of the plurality of network elements.

47. The network element of claim 45, wherein the memory further comprises operational instructions that cause the processing module to:
when the support needed is to drop the connection:
assign resources with respect to the adjacent one of the plurality of network elements not in the protected ring;
generate a network element link command to establish the communication link; and
provide the network element link command to the adjacent one of the plurality of network elements.

48. The network element of claim 36, wherein the memory further comprises operational instructions that cause the processing module to:
when the type of link command is a delete link command, determine whether the network element is a termination node of the communication link;
when the network element is not the termination node of the communication link, determine type of coupling to the adjacent one of the plurality of network elements;
when the type of coupling is linear:
delete allocation of resources of the network element to the communication link;
generate a network element delete link command; and
provide the network element delete link command to the adjacent one of the plurality of network elements.

49. The network element of claim 48, wherein the memory further comprises operational instructions that cause the processing module to:
when the network element is the termination node of the communication link:
delete allocation of resources of the network element to the communication link; and
generate an acknowledgement of deletion of the communication link.

50. The network element of claim 48, wherein the memory further comprises operational instructions that cause the processing module to:
when the type of coupling is a BLSR node:
determine support provided to the communication link;
when the support is an add node:
delete allocation of resources with respect to the adjacent one of the plurality of network elements;
delete resources in each network element of a back-up path;
generate a network element delete link command;
provide the network element delete link command to the adjacent one of the plurality of network elements;
when the support is a continue node:
delete allocation of resources with respect to the adjacent one of the plurality of network elements;
generate a network element delete link command;
provide the network element delete link command to the adjacent one of the plurality of network elements;
when the support is a drop node:
delete allocation of resources with respect to the adjacent one of the plurality of network elements not in the protected ring;
generate a network element delete link command;
provide the network element delete link command to the adjacent one of the plurality of network elements not in the protected ring.

51. The network element of claim 48, wherein the memory further comprises operational instructions that cause the processing module to:
when the type of coupling is a UPSR node:
determine type of support provided to the communication link;
when the type of support is add node:
delete resources with respect to the adjacent one of the plurality of network elements in a working path;
generate a network element delete link command;
provide the network element delete link command to the adjacent one of the plurality of network elements and to the network element in the working path;
delete resources with respect to an adjacent network element in a back-up path;
generate a local delete link command; and
provide the local delete link command to the adjacent network element in the back-up path;
when the type of support is continue node:
delete resources with respect to the adjacent one of the plurality of network elements;
generate the network element delete link command;
provide the network element delete link command to the adjacent one of the plurality of network elements and to the network element;
when the type of support is drop node:
delete selection of the back-up path or the working path as an active path;
delete resources with respect to the working path and the back-up path;
delete resources with respect to the adjacent one of the plurality of network elements not in the working path;
generate the network element delete link command; and
provide the network element delete link command to the adjacent one of the plurality of network elements and to the network element.

52. The network element of claim 36, wherein the memory further comprises operational instructions that cause the processing module to:
when the type of link command is a modify link command, determine whether the network element is a termination node of the communication link;
when the network element is not the termination node of the communication link:
determine type of coupling to the adjacent one of the plurality of network elements; and
delete resources of the plurality of network elements based on the type of coupling;
determine a second optimal path for a modified communication link via a second plurality of network elements of the communication network; and
process, as the second plurality of network elements, the modify link command based on the type of path to the second adjacent network element to establish the modified communication link.

53. A network element for using in a communication system, the network element comprises:
processing module; and
memory operably coupled to the processing module, wherein the memory includes operational instructions to:
receive a link command;
determine whether the link command is a network manager link command or a network element link command, wherein the link command identifies at least one of a first port and a second port of the communication link;
when the link command is a network manager link command:
determine type of the link command;
when the type of the link command is an establish a connection command:
determine an optimal path for the communication link via a plurality of network elements of the communication network;
determine type of path to an adjacent one of the plurality of network elements based on link coupling protocol of coupling to the adjacent one of the plurality of network elements; and
process the link command based on the type of path to the adjacent one of the plurality of network elements.

54. The network element of claim 53, wherein the memory further comprises operational instructions that cause the processing module to process the link command by:
when the link coupling protocol is UPSR, determining support needed for the communication link;
when the supported needed is to add a connection:
creating a protect ring having a working path and a back-up path;
assigning resources with respect to the adjacent one of the plurality of network elements in the working path;
generating a network element link command to establish the communication link; and
providing the network element link command to the adjacent one of the plurality of network elements.

55. The network element of claim 54, wherein the memory further comprises operational instructions that cause the processing module to:
assign resources with respect to an adjacent network element in the back-up path;
generate a local make link command; and
provide the local make link command to the adjacent network element.

56. The network element of claim 54, wherein the memory further comprises operational instructions that cause the processing module to:
when the support needed is to continue the connection:
assign resources with respect to the adjacent one of the plurality of network elements;
generate a network element link command to establish the communication link; and
provide the network element link command to the adjacent one of the plurality of network elements.

57. The network element of claim 54, wherein the memory further comprises operational instructions that cause the processing module to:
when the support needed is to drop the connection:
implement a selection of the working path or the back-up path as an initial active path;
assign resources with respect to the adjacent one of the plurality of network elements in the working path;
generate a network element link command to establish the communication link; and
provide the network element link command to the adjacent one of the plurality of network elements.

58. The network element of claim 53, wherein the memory further comprises operational instructions that cause the processing module to:
when the link coupling protocol is linear:
assign resources with respect to the adjacent one of the plurality of network elements in the working path;
generate a network element link command to establish the communication link; and
provide the network element link command to the adjacent one of the plurality of network elements.

59. The network element of claim 54, wherein the memory further comprises operational instructions that cause the processing module to process the link command by:
when the link coupling protocol is BLSR, determining support needed for the communication link;
when the supported needed is to add a connection:
creating a protect ring having a working path and a back-up path;
assigning resources in each network element of the back-up path;
assigning resources with respect to the adjacent one of the plurality of network elements in the working path;
generating a network element link command to establish the communication link; and
providing the network element link command to the adjacent one of the plurality of network elements.

60. The network element of claim 59, wherein the memory further comprises operational instructions that cause the processing module to:
when the support needed is to continue the connection:
assign resources with respect to the adjacent one of the plurality of network elements;
generate a network element link command to establish the communication link; and
provide the network element link command to the adjacent one of the plurality of network elements.

61. The network element of claim 59, wherein the memory further comprises operational instructions that cause the processing module to:
when the support needed is to drop the connection:
assign resources with respect to the adjacent one of the plurality of network elements not in the protected ring;
generate a network element link command to establish the communication link; and
provide the network element link command to the adjacent one of the plurality of network elements.

62. The network element of claim 53, wherein the memory further comprises operational instructions that cause the processing module to:
when the type of link command is a delete link command, determine type of coupling to the adjacent one of the plurality of network elements;
when the type of coupling is linear:
delete allocation of resources of the network element to the communication link;
generate a network element delete link command; and
provide the network element delete link command to the adjacent one of the plurality of network elements.

63. The network element of claim 62, wherein the memory further comprises operational instructions that cause the processing module to:
when the type of coupling is a BLSR node:
determine support provided to the communication link;
when the support is an add node:
delete allocation of resources with respect to the adjacent one of the plurality of network elements;
delete resources in each network element of a back-up path;
generate a network element delete link command;
provide the network element delete link command to the adjacent one of the plurality of network elements;
when the support is a continue node:
delete allocation of resources with respect to the adjacent one of the plurality of network elements;
generate a network element delete link command;
provide the network element delete link command to the adjacent one of the plurality of network elements;
when the support is a drop node:
delete allocation of resources with respect to the adjacent one of the plurality of network elements not in the protected ring;
generate a network element delete link command;
provide the network element delete link command to the adjacent one of the plurality of network elements not in the protected ring.

64. The network element of claim 62, wherein the memory further comprises operational instructions that cause the processing module to:
when the type of coupling is a UPSR node:
determine type of support provided to the communication link;
when the type of support is add node:
delete resources with respect to the adjacent one of the plurality of network elements in a working path;
generate a network element delete link command;
provide the network element delete link command to the adjacent one of the plurality of network elements and to the network element in the working path;
delete resources with respect to an adjacent network element in a back-up path;
generate a local delete link command; and
provide the local delete link command to the adjacent network element in the back-up path;
when the type of support is continue node:
delete resources with respect to the adjacent one of the plurality of network elements;
generate the network element delete link command;
provide the network element delete link command to the adjacent one of the plurality of network elements and to the network element;
when the type of support is drop node:
delete selection of the back-up path or the working path as an active path;
delete resources with respect to the working path and the back-up path;
delete resources with respect to the adjacent one of the plurality of network elements not in the working path;
generate the network element delete link command; and
provide the network element delete link command to the adjacent one of the plurality of network elements and to the network element.

65. The network element of claim 53, wherein the memory further comprises operational instructions that cause the processing module to:
when the type of link command is a modify link command, determine whether the network element is a termination node of the communication link;
when the network element is not the termination node of the communication link:
determine type of coupling to the adjacent one of the plurality of network elements; and
delete resources of the plurality of network elements based on the type of coupling;
determine a second optimal path for a modified communication link via a second plurality of network elements of the communication network; and
process, as the second plurality of network elements, the modify link command based on the type of path to the second adjacent network element to establish the modified communication link.

66. The network element of claim 53, wherein the memory further comprises operational instructions that cause the processing module to:
when the link command is a network element link command:
determine whether the network element is a termination node of the communication link;
when the network element is not a termination node of the communication link, determine an optimal path for the communication link via a plurality of network elements of the communication network;
determine type of path to an adjacent one of the plurality of network elements; and
process the link command based on the type of path to the adjacent one of the plurality of network elements.
